(19) United States
(12) Patent Application Publication
(10) Pub. No.: US 2018/0164260 A1
(43) Pub. Date: Jun. 14, 2018

(54) Chip-Scale Gas Chromatography

(71) Applicants: Masoud Agah, Blacksburg, VA (US); Muhammad Akbar, Blacksburg, VA (US); Bishnu Prasad Regmi, Blacksburg, VA (US)

(72) Inventors: Masoud Agah, Blacksburg, VA (US); Muhammad Akbar, Blacksburg, VA (US); Bishnu Prasad Regmi, Blacksburg, VA (US)

(21) Appl. No.: 15/836,405

(22) Filed: Dec. 8, 2017

Related U.S. Application Data
(60) Provisional application No. 62/431,476, filed on Dec. 8, 2016.
(60) Provisional application No. 62/467,387, filed on Mar. 6, 2017.

(51) Int. Cl. G01N 30/30; G01N 30/60

(52) U.S. Cl. CPC G01N 30/30; G01N 2030/025; G01N 30/6095

(57) ABSTRACT

A miniaturized gas chromatography system integrated on single chip comprising a sample injection unit, a separation column having an inlet, an exit and an interior surface, at least one detector located at the separation column exit and the sample injection unit having a T-shaped configuration. The column may be coated with room temperature ionic liquids, with and without an intermediate layer between the room temperature ionic liquid and the silicon surface.

### RELATED APPLICATIONS

This application claims the benefit of U.S. Provisional Application No. 62/431,476 filed Dec. 8, 2017 and U.S. Provisional Application No. 62/467,387 filed Mar. 6, 2017 both of which are herein incorporated by reference.

### STATEMENT REGARDING FEDERALLY SPONSORED RESEARCH & DEVELOPMENT

Not applicable.

### INCORPORATION BY REFERENCE OF MATERIAL SUBMITTED ON A COMPACT DISC

Not applicable.

### BACKGROUND OF THE INVENTION

Over the past several decades, the progress in microfabrication technology has revolutionized the fields of computing and signal processing as well as the automobile industry. The miniaturization of well-established analytical instruments is another paradigm in which the use of this technology has produced significant advancements. One such example is the gas chromatography (GC) system, which is used in various scientific, medical, and industrial settings to separate and analyze volatile organic compounds (VOCs). The monitoring of VOCs is of interest in various applications, including homeland security, space and fossil fuel exploration, worker exposure assessment and biomedical diagnostics. Miniaturized GCs (μGCs) are being intensely developed to enable the rapid diagnosis of VOCs in remote locations with low cost and low consumption. A typical μGC consists of three components: an injector/pre-concentrator for sample introduction, a micromachined column for VOC separation and a single detector or array of detectors located at the column exit to identify the separated compounds.

The majority of standalone μGC systems reported to date address the manual assembly of separately fabricated μGC components using commercially available off-chip fluidic interconnects. This approach is commonly known as the hybrid integration method. The hybrid integration method has certain benefits, such as the optimization of components and the absence of thermal crosstalk between individual μGC components.

Nevertheless, the implementation of μGC systems in a hybrid format is time consuming, cumbersome, expensive and prone to error. In addition, the hybrid format degrades the overall performance of μGCs due to the presence of cold spots between transfer lines. The condensation of compounds in these cold spots can result in extensive peak broadening. In particular, high boilers experience peak broadening in a more profound manner, which can negatively impact their analysis.

In contrast, chip-scale GC systems, in which all three components are located on a single chip, may suffer from thermal crosstalk between the individual μGC components. Thermal crosstalk can occur during two chromatographic events: 1) the desorption process of the pre-concentrator and 2) the temperature programming of the column. Thermal crosstalk could potentially change the retention time of a compound and also produce undesirable drift or noise in the detector signal.

These issues can be avoided in chip-scale GC platforms by developing an optimal back-end detector technology. Recently, there have been advancements in detector technology, and a wide variety of chemical detectors have been developed.

The micro helium discharge photoionization detector (μDPID) has demonstrated a minimum detection limit of approximately 10 pg, which is the same as that of a flame ionization detector (FID), which is mainly used in bench-top GC systems. The high sensitivity of μDPIDs reduces the system's reliance on the front-end pre-concentration step, which is typically performed to improve the detection limit of the detector. In addition, the μDPID can be easily integrated with a separation column. These two features of μDPIDs make them a promising candidate for developing chip-scale GC systems, thereby addressing the above-mentioned issues and improving the overall cost and performance of this technology.

The first μGC, which was developed in 1979, included a monolithic integrated sample injection loop, a 1.5 m long separation column and a separately fabricated thermal conductivity detector (TCD). The hybrid μGC system required the TCD to be integrated after fabrication. In addition, TCDs generally have poor sensitivity (e.g., detection limit of 10 parts per million) and also produce an unstable baseline when operated under flow and temperature programming conditions (the TCD temperature must be controlled to ±0.1° C. or better for baseline stability).

Sandia National Laboratories launched μChemLab™ for homeland security applications in 1998. Their research is unique in that it was focused on the development of a truly monolithic integrated μGC system. Their system included a preconcentrator, a separation column (86 cm long, 100 μm wide and 400 μm deep) and a magnetically actuated pivot plate resonator (PPR) fabricated on a silicon-on-insulator (SOI) wafer. Although the fabrication and subsequent coating mechanism for the integrated chip were demonstrated, no chromatogram was published using an on-chip PPR detector.

In addition, the heart of a GC system is the separation column which is crucial for overall performance of a chromatographic analysis. There have been intensive studies in the development of miniaturized separation columns, and in this regard micromachined silicon-glass chips have been a focus of several research studies. These columns can consume low power (less than 100 mW) and enable rapid temperature programming (up to 60° C./s). Additionally, it is possible to make micro columns of desired shapes and geometrical patterns which are otherwise unobtainable in traditional GC columns. These micromachined silicon columns have been successfully integrated with other microfabricated components to develop portable gas chromatography systems in both research and commercial laboratories.

The stationary phase coated inside microfabricated channels plays a central role in the separation process, and there have been considerable efforts to develop new stationary phase materials for micro columns (μCs). Several reports have been recently published on the use of monolayer-protected gold, carbon nanotubes, polymers, metal-organic frameworks, atomic layer-deposited alumina, sputtered oxides or graphite, and silica nanoparticles as stationary phases in μCs. Despite these encouraging studies, there is still a need to overcome a number of limitations and critical points. First, a considerable band broadening and/or tailing has been observed leading to a loss in separation power. Second, some of these microfabricated columns show limited chemical selectivity—although they show promising separation performance—thereby confining their applications. It is therefore desirable to develop and evaluate new stationary phases that can overcome the aforementioned limitations.

### BRIEF SUMMARY OF THE INVENTION

In one embodiment, the present invention provides a miniaturized gas chromatography (μGC) systems that can rapidly perform an analysis of volatile organic compounds (VOCs) in an extremely compact and low-power enabled platform.

In another embodiment, the present invention provides a compact chip-scale GC platform that has dimensions of 1.5 cm×3 cm. This lab-on-a-chip GC has three essential elements—a sample injector, separation column and detector—all on the same platform.

In another embodiment, the present invention provides a compact chip-scale GC platform that requires a loading time of a few seconds to introduce a VOC mixture into the chip, with the subsequent analysis performed in less than a minute for compounds with a wide range of boiling points (110-216° C.). This embodiment of the present invention is particularly suitable for producing low-cost and efficient μGC systems for the rapid analysis of compounds in real-time situations.

In another embodiment, the present invention provides a microfabrication method for the single chip integration of the key components of a μGC system in a two-step planar fabrication process. The 1.5 cm×3 cm microfluidic platform includes a sample injection unit, a micromachined semi-packed separation column (μSC) and a micro helium discharge photoionization detector (μDPID). The sample injection unit consists of a T-shaped channel operated with an equally simple setup involving a single 3-way fluidic valve, a micropump for sample loading and a carrier gas supply for subsequent analysis of the VOCs. This preferred embodiment only requires a loading time of only a few seconds and produces sharp and repeatable sample pulses (full width at half maximum of approximately 200 ms) at a carrier gas flow rate that is compatible with efficient chromatographic separation.

In another embodiment, the present invention provides a compact chip-scale GC platform having a wide variety of VOCs with boiling points in the range of 110-216° C. that can be analyzed in less than 1 minute by optimizing the flow and temperature programming conditions. Moreover, the analysis of four VOCs at the concentration level of 1 part per million in an aqueous sample (which corresponds to a headspace concentration in the lower parts-per-billion regime) was performed with a sampling time of only 6 s.

In another embodiment, the present invention provides a compact chip-scale GC platform having a linear dynamic range over three orders of magnitude. The embodiments of the present invention may be used to monitor hazardous VOCs in real time in industrial workplaces and residential settings

In another embodiment, the present invention provides a high-speed and efficient gas chromatographic separation of a mixture of organic compounds using semi-packed columns (SPCs) coated with room temperature ionic liquids (RTILs). A 1 m long, 240 μm deep, 190 μm wide column with embedded circular micropillars of 20 μm in diameter and 40 μm post spacing may be fabricated using microelectromechanical systems (MEMS) technology.

In another embodiment, two conventional RTILs were deposited inside the channels of the SPCs, and these columns were tested for gas chromatographic separation of a mixture of 12 compounds spanning a wide boiling point range (80 to 214° C.). The separation was achieved in 45 seconds with a separation efficiency of approximately 3000 plates/m.

In yet other embodiments, the present invention may use a dynamic coating method to deposit one or more RTILs in the channels of microfabricated SPCs. These columns may be used to separate a number of different chemical mixtures comprising both polar and non-polar compounds. These RTIL-coated SPCs displayed sharp and symmetrical peaks, offered high separation efficiency, and increased the separation speed. The number of theoretical plates obtained using helium as a carrier gas was as high as 2300 plates per meter.

In yet another embodiment, a [BPyr][NTf2]-coated column may also be used in the separation of BTEX and naphthalene.

The embodiments of the present invention using RTILs may be used as excellent stationary phases for SPCs, thereby dramatically expanding the range of complex mixtures that could be analyzed using a micro gas chromatograph.

In yet another embodiment, coating of the silicon surface with atomic layer deposited alumina or atomic layer deposited hafnium oxide prior to the deposition of an RTIL produced significant improvement in separation performance. The separation efficiency as measured by the plate numbers (or number of theoretical plates) was found to be approximately 8,000 plates per meter (“plates/m”). This number is two times plate number obtained by directly immobilizing the RTIL on silicon surface. This shows that the surface on which an RTIL is immobilized plays a major role in separation performance. Other surfaces that can be used include gold, platinum, other inert metals, metal carbides, and metal nitrides.

In other embodiments, the present invention provides a miniaturized gas chromatography system integrated on single chip comprising a sample injection unit having a T-shaped configuration; a separation column having an inlet, an exit and an interior surface and; at least one detector located at the separation column exit.

In other embodiments, the present invention provides a miniaturized gas chromatography system that reduces the need for heated interconnect lines between individual components of μQC reducing the footprint, cost and power budget for the operation of μQC technology.

In other embodiments, the present invention provides a miniaturized gas chromatography system that reduces band-broadening of compounds having high molecular weight thus improving the performance of μQC technology.

In other embodiments, the present invention provides a miniaturized gas chromatography system including a plurality of separation columns each having an interior surface, the interior surfaces coated with one or more room temperature ionic liquid films.

In other embodiments, the present invention provides a miniaturized gas chromatography system wherein the interior surface of the separation column has a silicon surface, the silicon surface coated with an alumina surface, the alumina surface coated with a one or more room temperature ionic liquid films.

In other embodiments, the present invention provides a miniaturized gas chromatography system wherein the interior surface of the separation column has a silicon surface, the silicon surface coated with a hafnium oxide surface, the hafnium oxide surface coated with a one or more room temperature ionic liquid films.

In other embodiments, the present invention provides a miniaturized gas chromatography system wherein the at least one detector, i.e. micro discharge photoionization (μDPID), has a response that remains linear to an injected mass of the test compounds.

In other embodiments, the present invention provides a miniaturized gas chromatography system wherein the at least one detector, i.e. micro discharge photoionization (μDPID), has a response that remains linear to an injected mass of the test compounds over three orders of magnitude.

In other embodiments, the present invention provides a miniaturized gas chromatography system wherein the at least one detector, i.e. micro discharge photoionization (μDPID), has a minimum detection limit of 10 pg comparable to commercialized flame ionization detector (FID).

In other embodiments, the present invention provides a miniaturized gas chromatography system wherein the detection limit of 10 pg can be improved further by the optimizing gap between the excitation electrodes, the collector volume, packaging of the detector and density of micro-plasma.

In other embodiments, the present invention provides a miniaturized gas chromatography system having the ability to operate under temperature programming conditions to reduce analysis time.

In other embodiments, the present invention provides a miniaturized gas chromatography system that can be integrated with other types of detectors such as micro thermal conductivity detector (μTCD).

In other embodiments, the present invention provides a miniaturized gas chromatography system having a separation efficiency of approximately 3000 plates/m.

In other embodiments, the present invention provides a miniaturized gas chromatography system wherein separation is achieved in 45 seconds with a separation efficiency of approximately 3000 plates/m.

In other embodiments, the present invention provides a miniaturized gas chromatography system having a separation efficiency of approximately 8000 plates/m.

In other embodiments, the present invention provides a miniaturized gas chromatography system wherein the interior surface of the separation column has a silicon surface, the silicon surface coated with a gold surface, the gold surface coated with a one or more room temperature ionic liquid films.

In other embodiments, the present invention provides a miniaturized gas chromatography system wherein the interior surface of the separation column has a silicon surface, the silicon surface coated with a platinum surface, the platinum surface coated with a one or more room temperature ionic liquid films.

In other embodiments, the present invention provides a miniaturized gas chromatography system wherein the interior surface of the separation column has a silicon surface, the silicon surface coated with an inert metal surface, the inert metal surface coated with a one or more room temperature ionic liquid films.

In other embodiments, the present invention provides a miniaturized gas chromatography system including a pump in communication with a branch of the T-shaped sample injection unit, the pump creates a negative pressure to load a gaseous sample present above the headspace of a liquid into a fluidic channel formed by two branches of the T-shaped sample injection unit and away from the separation column. This preconcentrates the sample.

In other embodiments, the present invention provides a miniaturized gas chromatography system wherein the miniaturized gas chromatography system has a fast sample introduction (full width at half maximum of approximately 200 ms at room temperature) and repeatable injection of samples into the separation column.

In other embodiments, the present invention provides a miniaturized gas chromatography system wherein system of claim 1 can be improved further by heating the T-shaped injector making it comparable to the commercially available GC injectors.

In other embodiments, the present invention provides a miniaturized gas chromatography system wherein the T-shaped sample injection unit of can be further used to inject liquid samples. Thus, there is potential for this injector technology to be utilized for other analytical tools/applications beside μGC.

In other embodiments, the present invention provides a miniaturized gas chromatography system wherein the T-shaped sample injection unit of can be replaced with micropillars coated with variety of commercially available adsorbents to trap analyte of interest (selective, nonselective adsorption) and release them on demand through thermal desorption process.

In other embodiments, the present invention provides a miniaturized gas chromatography system wherein the pump after creating the negative pressure creates a positive pressure which injects a sample into the separation column.

In other embodiments, the present invention provides a miniaturized gas chromatography system further including a valve which cooperates with the pump to create negative pressure and positive pressure.

In other embodiments, the present invention provides a miniaturized gas chromatography system wherein the interior surface of the separation column has a silicon surface, the silicon surface coated with a material that increases the uniformity of the one or more room temperature ionic liquid films.

In other embodiments, the present invention provides a miniaturized gas chromatography system wherein the interior surface of the separation column has a silicon surface, the silicon surface coated with an oxide that increases the uniformity of the one or more room temperature ionic liquid films.

In other embodiments, the present invention provides a miniaturized gas chromatography system wherein the interior surface of the separation column has a silicon surface, the silicon surface coated with an oxide surface, the oxide surface coated with one or more room temperature ionic liquids.

In other embodiments, the present invention has a separation efficiency of approximately 8000 plates/m and where the separation of 21 compounds is achieved in approximately 3 minutes.

In other embodiments, the present invention provides a miniaturized gas chromatography system wherein the interior surface of the separation column has a silicon surface, the silicon surface is coated with a metal carbide surface and the metal carbide surface is coated with a one or more room temperature ionic liquid films.

In other embodiments, the present invention provides a miniaturized gas chromatography system wherein the interior surface of the separation column has a silicon surface, the silicon surface is coated with a metal nitride surface and the metal nitride surface is coated with a one or more room temperature ionic liquid films.

In other embodiments, the present invention provides a miniaturized gas chromatography system integrated on single chip comprising a sample injection unit; a separation column having an inlet, an exit and an interior surface; at least one detector located at the separation column exit; and the sample injection unit including micropillars coated with adsorbent to trap analytes of interest and release them on demand through a thermal desorption process.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1A shows the configuration of the fluidic interconnections between the chip, valve, micropump and carrier gas for an embodiment of the present invention.

FIG. 1B is a top image showing the loading phase, whereas the bottom one shows the injection phase for an embodiment of the present invention.

FIG. 1C shows a coating mechanism for the μSC for an embodiment of the present invention.

FIG. 1D shows an electrical circuit for measuring the current signal produced by the ionization of VOCs for an embodiment of the present invention.

FIG. 2A is a top view SEM image of a semi-packed μSC column showing the channel with embedded 20 μm circular micropillars for an embodiment of the present invention.

FIG. 2B is a cross-sectional SEM image of a semi-packed μSC column showing high-aspect-ratio pillars for an embodiment of the present invention.

FIG. 2C is an optical image of a semi-packed μSC column showing the packaged chip for an embodiment of the present invention.

FIG. 3A shows the effect of the carrier gas flow rate on the FWHM value of the injection plug for an embodiment of the present invention. The curves were approximated with a polynomial trend line of order 2. The R-squared values were 0.88, 0.96, 0.91, 0.98 and 0.97 for heptane, toluene, chlorobenzene, ethylbenzene and p-xylene, respectively. The standard error calculated for each point over triplicate runs were <10%, showing that the sample injection unit produces repeatable injections.

FIG. 3B shows the effect of the carrier gas flow rate on the peak height of the injection plug for an embodiment of the present invention. The curves were approximated with a linear trend line. The R-squared values were 0.96, 0.96, 0.99, 0.96 and 0.97 for heptane, toluene, chlorobenzene, ethylbenzene and p-xylene, respectively. The standard errors calculated for each point over triplicate runs were <10%.

FIG. 4A shows the calibration curves for the μDPID produced by injecting different masses (10 pg-13 ng) of four test compounds and calculating the response (peak area) for an embodiment of the present invention. Each point was repeated in triplicate, and the average value was plotted against the injected mass. Linear regression (forced zero Y-intercept) R² values are shown for each compound. The slopes (A.s g⁻¹) were 0.0361, 0.0488, 0.0841 and 0.2171 for tetrachloroethylene, toluene, chlorobenzene and ethylbenzene, respectively.

FIG. 4B shows the corresponding curves plotted on a log-scale for clarity for an embodiment of the present invention.

FIG. 5A shows the response of the μDPID to a 3 second headspace sampling of a nine-compound mixture under isothermal conditions at 40° C. and a flow rate of 0.77 mL min⁻¹ at the chip outlet for an embodiment of the present invention.

FIG. 5B shows the corresponding chromatogram generated by the FID for an embodiment of the present invention.

FIG. 6A shows the response of the μDPID to a 3 second headspace sampling of a ten-compound mixture under the flow programming and isothermal conditions at 40° C. for an embodiment of the present invention. The initial and final flow rates through the column outlet were 0.77 and 1 mL min⁻¹, respectively.

FIG. 6B shows the response of the μDPID to a 3 second headspace sampling of a ten-compound mixture under the flow and temperature programming conditions for an embodiment of the present invention. The initial and final flow rates through the column were 0.77 and 0.9 mL min⁻¹, respectively.

FIG. 6C shows the response of the μDPID to a 6 second headspace sampling of a seven-compound mixture containing high-boiling-point compounds under isothermal conditions of 70° C. and a flow rate of 0.9 mL min⁻¹ at the chip outlet for an embodiment of the present invention.

FIG. 6D shows the response of the μDPID to a 6 second headspace sampling of a four-compound mixture diluted to a concentration of 1 ppm in the aqueous phase for an embodiment of the present invention. The corresponding concentrations in the headspace calculated using Henry's Law are 270 (toluene), 152 (chlorobenzene), 323 (ethylbenzene) and 314 ppb (p-xylene). The flow rate at the chip outlet was set to 0.77 mL min⁻¹.

FIG. 7A is an optical micrograph of SPCs uncoated.

FIG. 7B is an optical micrograph of SPCs coated with [P66614][NTf2].

FIG. 7C is an optical micrograph of SPCs coated with [BPyr][NTf2].

FIG. 8 shows variation of HETP as a function of the average velocity of the carrier gas (helium) for columns coated with two different RTILs. The HETP was determined using naphthalene as a probe under isothermal conditions. Chromatographic conditions for each column: injection volume 0.1 μL (2% naphthalene in heptane), split ratio 100:1, inlet temperature 280° C., detector temperature 300° C., and the oven temperature 100° C. The inlet pressure was varied from 2.5 to 45 psi. The legend shows the RTIL deposited in each column.

FIG. 9A shows separation of 15-compound mixture using Separation of a 15-compound mixture using [P66614][NTf2]-coated columns. Chromatographic conditions: injection volume 0.1 μL split ratio 400:1, inlet pressure 17.5 psi for 0.8 min and then ramped to 25 psi at the rate of 60 psi/min, oven temperature 30° C. for 0.3 min and then ramped at the rate of 40° C./min to 150° C. (for a) or 130° C. (for b). Peak identification: (1) heptane, (2) benzene, (3) toluene, (4) ethylbenzene, (5/6) p- and m-xylenes, (7) o-xylene, (8) styrene, (9) benzyl chloride, (10) 1,2-dichlorobenzene, (11) 1,2,4-trichlorobenzene, (12) naphthalene, (13) 2-nitrotoluene, (14) 3-nitrotoluene, and (15) 4-nitrotoluene. The 15 compounds are separated in approximately 3 minutes.

FIG. 9B shows separation of 15-compound mixture using Separation of a 15-compound mixture using [BPyr][NTf2]-coated columns. Chromatographic conditions: injection volume 0.1 μL. split ratio 400:1, inlet pressure 17.5 psi for 0.8 min and then ramped to 25 psi at the rate of 60 psi/min, oven temperature 30° C. for 0.3 min and then ramped at the rate of 40° C./min to 150° C. (for a) or 130° C. (for b). Peak identification: (1) heptane, (2) benzene, (3) toluene, (4) ethylbenzene, (5/6) p- and m-xylenes, (7) o-xylene, (8) styrene, (9) benzyl chloride, (10) 1,2-dichlorobenzene, (11) 1,2,4-trichlorobenzene, (12) naphthalene, (13) 2-nitrotoluene, (14) 3-nitrotoluene, and (15) 4-nitrotoluene. The 15 compounds are separated in less than 3 minutes.

FIG. 10A shows separation of a mixture of 8 fatty acid methyl esters using [P66614][NTf2]-coated columns. The identity of each peak is labeled. Insets show the magnified view of the selected regions. Chromatographic conditions: injection volume 0.1 μL split ratio 100:1, inlet pressure 17.5 psi for 0.8 min and then ramped to 25 psi at the rate of 60 psi/min, oven temperature 30° C. for 0.3 min and then ramped at the rate of 40° C./min to 170° C. and held at 170° C.

FIG. 10B shows separation of a mixture of 8 fatty acid methyl esters using [BPyr][NTf2]-coated columns. The identity of each peak is labeled. Insets show the magnified view of the selected regions. Chromatographic conditions: injection volume 0.1 μL, split ratio 100:1, inlet pressure 17.5 psi for 0.8 min and then ramped to 25 psi at the rate of 60 psi/min, oven temperature 30° C. for 0.3 min and then ramped at the rate of 40° C./min to 170° C. and held at 170° C.

FIG. 11 shows separation of neat gasoline sample using a [BPyr][NTf2]-coated column. Chromatographic conditions: injection volume 0.1 μL, split ratio 100:1, inlet pressure 17.5 psi for 0.8 min and then ramped at the rate of 60 psi/min to 25 psi and hold at the pressure, oven temperature 30° C. for 0.3 min and then ramped at the rate of 40° C./min to 170° C. and hold at 170° C. for 1 min. Insets show the magnified view of selected regions. The numbered peaks are those whose retention times match with the known compounds shown in FIG. 9B.

FIG. 12 is an overlay of chromatograms for the separation of gasoline (solid) and 15-component standard mixture (dashed) using a [BPyr][NTf2]-coated column. Inset shows the magnified view of the selected region. The peaks with retention time match are labeled.

FIG. 13 shows an acetone peak obtained at 50° C. under inlet pressure of 20 psi. Injection volume was 0.1 μL with a split ratio of 400:1. Number of theoretical plates is 2121 per meter.

FIG. 14 shows the variation of the number of theoretical plates as a function of average linear velocity of mobile phase (helium) for different columns prepared by immobilizing RTILs on three different surfaces: silicon, hafnium oxide, and alumina. The interfaces are indicated in the legend. The error bars indicate the standard deviations of the number of theoretical plates for three different independently coated columns using 0.8% (w/v) solution of [BPyr][NTf2] (shown for silicon surface only). The number of theoretical plates were determined using naphthalene as a probe under isothermal conditions. Chromatographic conditions for each column: injection volume 0.1 μL (0.5% w/v of naphthalene in hexane), split ratio 200:1, inlet temperature 280° C., detector temperature 300° C., and oven temperature 100° C. The inlet pressure was varied from 2.5 to 55 psi. The average velocity was calculated my using methane as an unretained solute.

FIG. 15 is a chromatogram showing the separation of a 21-component mixture of organic compounds using a column prepared by depositing [BPyr][NTf₂] on alumina surface. Chromatographic conditions: injection volume 0.1 μL. split ratio 400:1, inlet pressure 25 psi for 0.5 min and then ramped to 35 psi at the rate of 60 psi/min, oven temperature 30° C. for 0.5 min and then ramped at the rate of 40° C./min to 130° C. The insets show magnified view of selected region. Peak numbers refer to: (1) heptane, (2) octane, (3) nonane, (4) benzene, (5) toluene, (6) ethylbenzene, (7) p-xylene, (8) m-xylene, (9) o-xylene, (10) 2-chlorotoluene, (11) isobutylbenzene, (12) styrene, (13) butylbenzene, (14) 1,2-dichlorobenzene, (15) 2,5-dichlorotoluene, (16) 1,2,4-trichlorobenzene, (17) benzyl chloride, (18) naphthalene, (19) 2-nitrotoluene, (20) 3-nitrotoluene, and (21) 4-nitrotoluene. The 21 compounds are separated in less than 3 minutes.

FIG. 16 is a chromatogram showing the separation of a 21-component mixture of organic compounds using a column prepared by depositing [P₆₆₆₁₄][NTf₂] on alumina surface. Chromatographic conditions: same as those of FIG. 15 except that the column was heated up to 140° C. The peak numbers correspond to the compounds described in the caption of FIG. 15. Note the order of elution is altered as compared to that of FIG. 15. The 21 compounds are separated in approximately 3 minutes.

FIG. 17A is a chromatogram showing the separation of a kerosene sample using a column coated with [P66614][NTf2] on alumina surface. Chromatographic conditions: injection volume 0.1 μL, split ratio 400:1, inlet pressure 25 psi for 0.5 min and then ramped to 35 psi at the rate of 60 psi/min, oven temperature 30° C. for 0.5 min and then ramped at the rate of 40° C./min to 170° C. for kerosene and to 190° C. and held at 190° C. for 1.5 mins for diesel. The insets show the magnified views of the selected regions. The major peaks were identified by comparing the retention time of the peaks to a standard mixture of (C₇-C₃₀) n-alkanes.

FIG. 17B is a chromatogram showing the separation of a diesel sample (b) using a column coated with [P66614][NTf2] on alumina surface. Chromatographic conditions: injection volume 0.1 μL, split ratio 400:1, inlet pressure 25 psi for 0.5 min and then ramped to 35 psi at the rate of 60 psi/min, oven temperature 30° C. for 0.5 min and then ramped at the rate of 40° C./min to 170° C. for kerosene and to 190° C. and held at 190° C. for 1.5 mins for diesel. The insets show the magnified views of the selected regions. The major peaks were identified by comparing the retention time of the peaks to a standard mixture of (C₇-C₃₀) n-alkanes.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

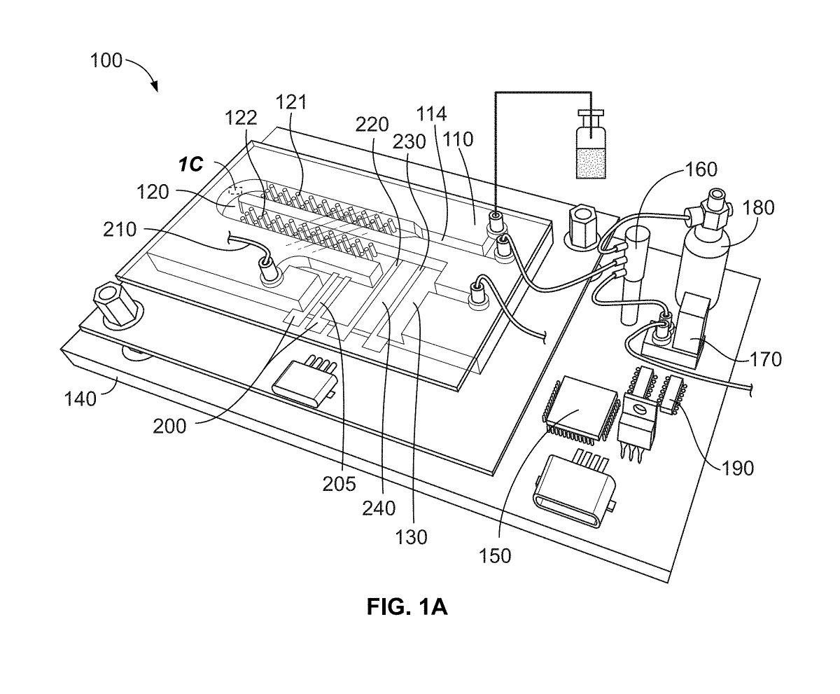

FIGS. 1A-1D illustrates the configuration of the fluidic connections between the chip, valve, miniaturized pump and helium carrier gas supply for an embodiment of the present invention. For this embodiment, the present invention provides an integrated μGC analysis system 100 that has all of the important features of a lab-on-a-chip platform. It has a sample injection unit 110, a microseparation column 120 and a detector 130, all of which are integrated on a 1.5 cm×3 cm platform 140.

The integration of the μGC components on a common substrate reduces the footprint of this technology, enhances the overall performance and allows for a lower fabrication cost. Furthermore, each component can perform its role effectively and rapidly; for example, sample injection unit 110, which may be made of a plurality of branches that form a T-shape 111 as shown in FIG. 1B. The T-shape design requires a loading time of a few seconds to produce sharp injections (FWHM of approximately 200 ms). Similarly, the subsequent operation of the system under the temperature and flow programming conditions allows for a rapid analysis of complex VOC mixtures. In addition, the excellent detection limit (approximately 10 pg), response time (approximately 200 ms) and linearity of the μDPID (three orders of magnitude) demonstrates the potential of this preferred embodiment for use in μGC technology.

FIG. 1A also illustrates the configuration of the fluidic connections between the chip 150, valve 160, miniaturized pump 170 and helium carrier gas supply 180. The valve position and pump are controlled by an 8-bit microcontroller 190 interfaced with a keypad to initiate the command. The operation of the chip-scale GC platform is quite straightforward. In normal operation, valve 160 is connected to the carrier gas supply 180. The sample inlet port 110 is manually inserted into a sealed vial containing the unknown mixture of VOCs. To avoid liquid phase injection, the sample inlet port 110 is kept in the headspace volume above the sample. To perform an injection, a single command from the keyboard initiates a sequence of events, which is completed within a few seconds. First, valve 160 is switched to the pump position, and the pump is turned on. The pump applies a negative pressure (flow rate of 1 mL min⁻¹) to load the sample into the fluidic channel 114 which is formed by branches 112B and 112C (internal volume of approximately 1.2 μL) connecting the valve and chip. As shown in FIG. 1B, the negative pressure draws the samples away from the separation column 120. This concentrates the sample. Then, the valve position is turned again to the carrier gas position, which has a positive pressure that injects the sample 117 past branch 112A and into the μSC 120 (FIG. 1B). The sample moves through the μSC with helium carrier gas and is separated into individual compounds. The separation process is based on the relative solubility of the compounds in the silane-treated alumina stationary phase (FIG. 1C) and their relative vapor pressures. As the compounds are separated in space and time, they elute from the μSC and are ionized with high-energy (>10 eV) photons. These photons are generated through a microplasma produced in helium by applying a DC voltage of 550 V across a pair of excitation electrodes 200. The gap 205 between the excitation electrodes 200 is approximately 20 μm. The microplasma is sustained by a constant supply of helium from the auxiliary channel 210. A 50 MΩ ballast resistor is connected in series with the excitation electrode 200 to limit the current flow, which could potentially damage the electrodes. In addition to the pair of excitation electrodes 200, the detector has a bias 220 and collector electrode 230. The bias and collector electrodes are 1.5 mm apart, and the space between them is called the collector volume 240.

The circuit shown in FIG. 1D measures the signal in the form of an electrical current, which is produced through the ionization of VOCs. Here, a pico-ammeter 250 and the bias voltage 260 are connected in series to the collector and bias electrode, respectively. The positive voltage applied to the bias electrode assists in capturing the electron inside the collector volume. The recombination of electrons with the ionized species can reduce the measured current. The current measured by the pico-ammeter is fed to the Keithley 2700 multimeter (Tektronix, Beaverton, Oreg., USA), which communicates with the LABVIEW program to plot the output signal.

All VOCs listed in Table 1 were purchased from Sigma-Aldrich (St. Louis, Mo.) with >99% purity.

TABLE 1

| VOC | pᵥ | B.P | Ionization Potential |
|---|---|---|---|
| Toluene | 22.0 | 110 | 8.82 |
| Tetrachloroethylene | 14.2 | 121 | 9.32 |
| Chlorobenzene | 11.7 | 131 | 9.07 |
| Ethylbenzene | 9.9 | 136 | 8.76 |
| p-xylene | 9.0 | 138 | 8.45 |
| n-nonane | 4.6 | 151 | 9.7 |
| Bromobenzene | 4.2 | 156 | 8.98 |
| n-decane | 1.4 | 174 | 9.6 |
| 1,2-dichlorobenzene | 1.0 | 180 | 9.07 |
| n-undecane | 0.4 | 196 | 9.6 |
| 1,2,4-trichlorobenzene | 0.3 | 214 | 9.04 |
| n-dodecane | 0.3 | 216 | — |

pᵥ: Vapor Pressure (mm of Hg) at 20° C.
LP: Ionization potential (eV).
Physical properties of the volatile organic compounds used in this study.

Silicon wafers (n-type, 4 in. diameter, 500 μm thickness, single side polished) and Borofloat wafers (4 in diameter, 700 μm thickness, double side polished) used to fabricate the embodiments of the present invention were purchased from University Wafers (Boston, Mass.) and Coresix Precision Glass (Williamsburg, Va.), respectively. Ultra-high-purity helium (UHP 300) was purchased from Airgas (Christiansburg, Va.). Fused silica capillary tubes (100 μm I.D. and 200 μm O.D.) were purchased from Polymicro Technologies (Phoenix, Ariz.). The miniaturized pump (P/N SP 270 EC-LC-L) and 3-way latching solenoid valve (LHLA0521111H) were purchased from Schwarzer Precision (Germany) and Lee Company (Westbrook, Conn.), respectively.

For a preferred embodiment of the present invention, a method of chip fabrication follows the following processing steps. As shown in FIG. 1B, each branch 112A-112C of the T-shaped 111 of sample injection unit 110 is 2 mm long and 250 μm wide. The T-shaped injection unit, separation stage 120 (1 m long, 190 μm wide and 240 μm deep with 20 μm embedded circular pillars 121-122), fluidic ports and cavity for the detector were fabricated in silicon using the bulk micromachining technique. Atomic layer deposition (ALD) was used to coat a thin layer of alumina (approximately 10 nm) at 250° C., which serves as a stationary phase. The detector electrodes were fabricated on the Borofloat wafer by evaporating 700 nm/40 nm of Ti/Au. The silicon and Borofloat wafers were diced, and the individual devices were bonded together. Next, the detector cavity was sealed with epoxy, electrical wires were soldered to the bond pads and capillary tubes were inserted into the four ports of the chip. A solution containing 10 mM chlorodimethyloctadecylsilane (CDOS) in toluene was filled in the μSC and left at room temperature for 24 h. Finally, the solution was purged with nitrogen for 30 min. The μSC was conditioned inside the conventional GC system for approximately 1 h (35° C., ramped at 2° C./min to 140° C.) at a constant helium pressure of 10 psi.

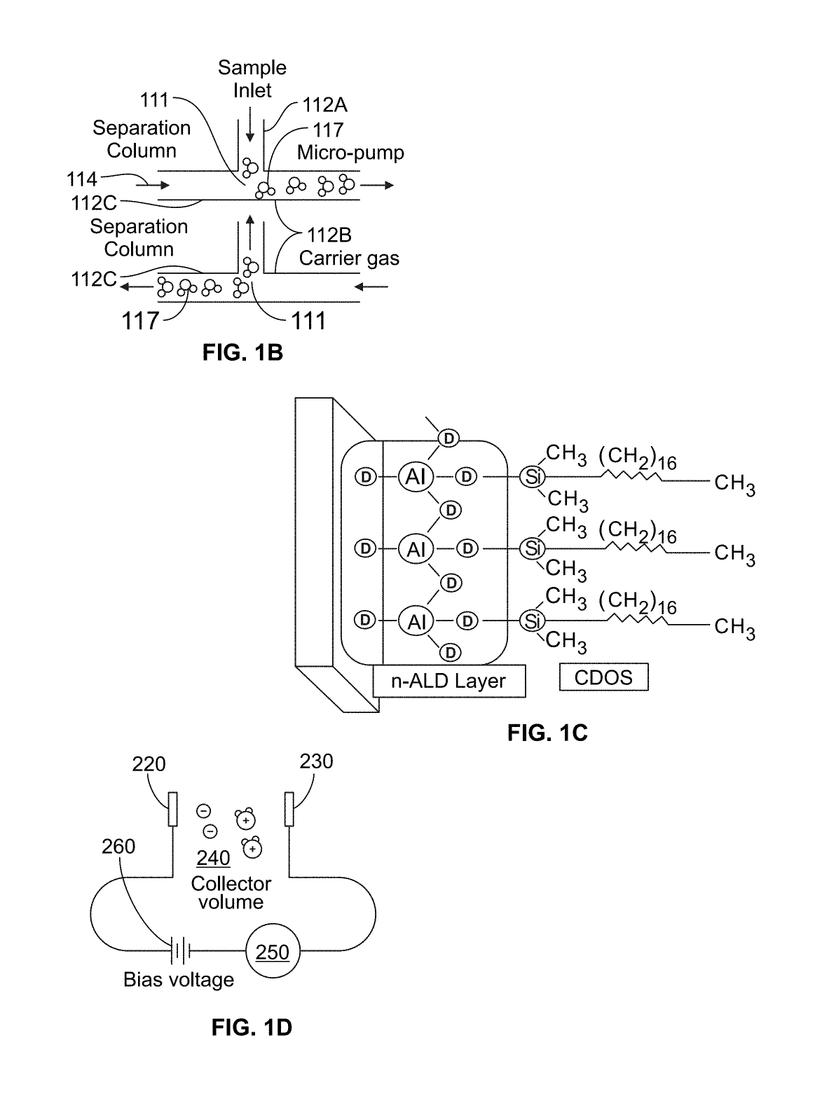

The top and cross-sectional images of the μSC using scanning electron microscopy (SEM) are shown in FIGS. 2A and 2B, respectively. The optical image of the packaged device is shown in FIG. 2C with the capillaries attached to all four ports of the chip and the electrical connections in place.

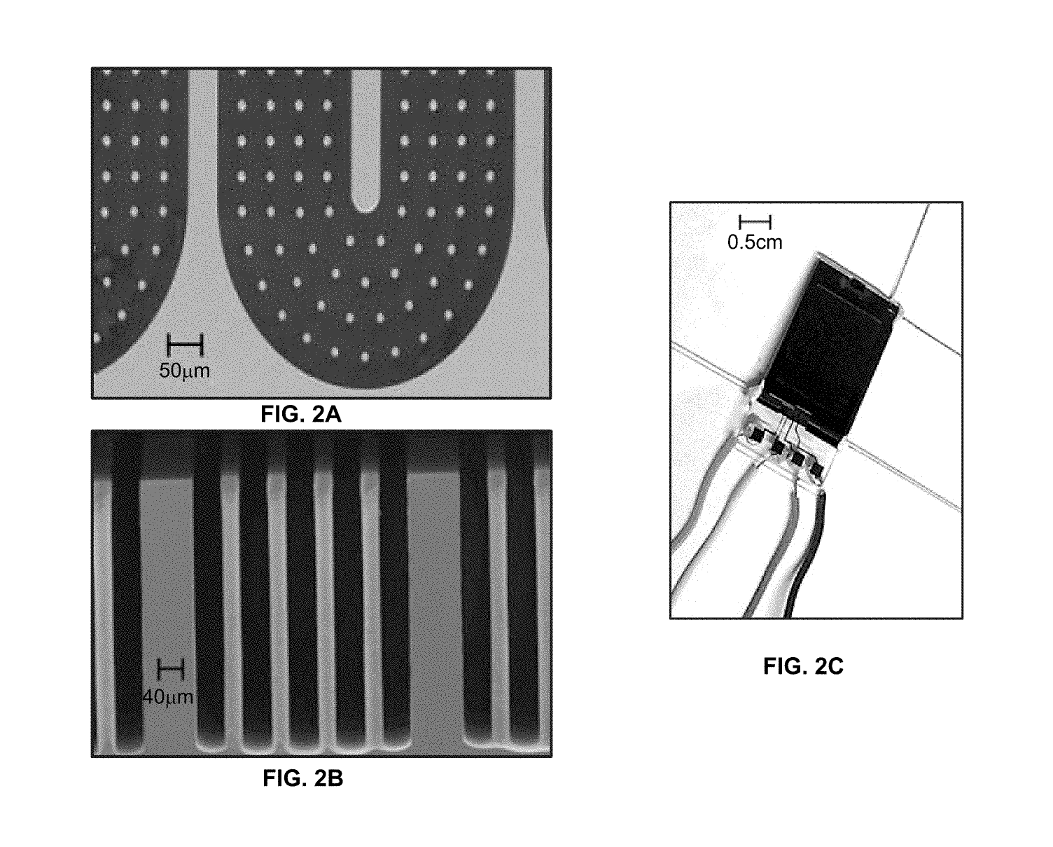

The performance of the sample injection unit was characterized in terms of the peak parameters (full width at half maximum [FWHM], peak height and area). Five compounds—heptane, toluene, chlorobenzene, ethylbenzene and p-xylene—were used. Each compound was separately injected at flow rates set to five discrete values of 0.3, 0.45, 0.72, 1 and 1.4 mL min⁻¹. These flow rates correspond to inlet pressures of 10, 15, 20, 25 and 30 psi. The loading time of 500 ms was used for all VOCs. The outlet of the injector was connected to the FID installed in the conventional GC system (HP 7890). Triplicate runs were performed for each value, and the average values of the FWHM and peak height were plotted, as shown in FIG. 3.

The results illustrate that for all VOCs, the FWHM depends on the injector flow rate condition. All compounds experienced a sharp decrease in FWHM between 0.3 and 0.72 mL min⁻¹ followed by a more gradual decrease. A similar trend has been observed previously and when a 20 cm-long uncoated capillary tube was connected between a conventional GC injector and the FID. The inverse proportionality of the FWHM with the flow rate can be attributed to different factors. First, increasing the carrier gas flow rate will increase the sample injection rate from the sample loop to the detector, which reduces the extra-column band broadening. Second, the solutes are swept faster, and the longitudinal diffusion in the mobile phase is decreased as a result. Molecules diffuse in the carrier gas from the region of high concentration to that of lower concentration over time.

Increasing the flow rate decreases the time that molecules spend in the injector and connecting tubes, and therefore, the diffusion of molecules in the carrier gas decreases, which results in lower FWHM values. Furthermore, the on-chip injector tested herein operates at room temperature, which can contribute to the differences in the FWHM of high-and low-volatility compounds. In summary, the overall decreases in the FWHM for heptane, toluene, chlorobenzene, ethylbenzene and p-xylene over the entire flow rate range were 40%, 59%, 59%, 50% and 64%, respectively.

Because the FID is sensitive to the mass flow rate, the decrease in the FWHM was compensated for by a corresponding increase in the peak height to maintain uniform peak area. FIG. 3B shows that the peak height increases linearly over the entire flow rate range (0.3-1.4 mL min⁻¹) for all VOCs. This increase in the peak height is attributed to the increase in mass over time, as measured by the FID. The peak area for all compounds remained approximately constant for all flow rate conditions. Peak areas were calculated to be approximately 20 pA×s for these compounds except for ethylbenzene, which had a peak area of 35 pA×s.

Furthermore, the repeatability of the sample injection unit was investigated by monitoring the change in the peak parameters (FWHM, peak height and area) over multiple headspace injections. For this purpose, toluene was chosen as a test compound, and multiple injections were performed in succession approximately every 30 s. The flow rate in this experiment was set to 1.4 mL min⁻¹. The sample injection unit produced highly repeatable results, with less than 5% variation in the standard error values for peak parameters over six injections. The FWHMs for these injections were approximately 200 ms.

The μDPID of an embodiment of the present invention using T-shape unit 111 has a minimum detection limit of approximately 10 pg, a response time of approximately 200 ms and highly stable excitation electrodes over a long period of time. To evaluate the linear range of a μDPID for this embodiment of the present invention, the inlets of the detector were connected to injectors A and B of the conventional GC system. The pressures of injectors A and B were set to 15 and 10 psi, respectively. A DC voltage of 550 V was applied (using PS-310, Stanford Research Systems) to create the discharge, and the bias voltage was set to 30 V. This value of the bias voltage was selected based on previous work, which showed the enhanced sensitivity of the detector at 30 V.

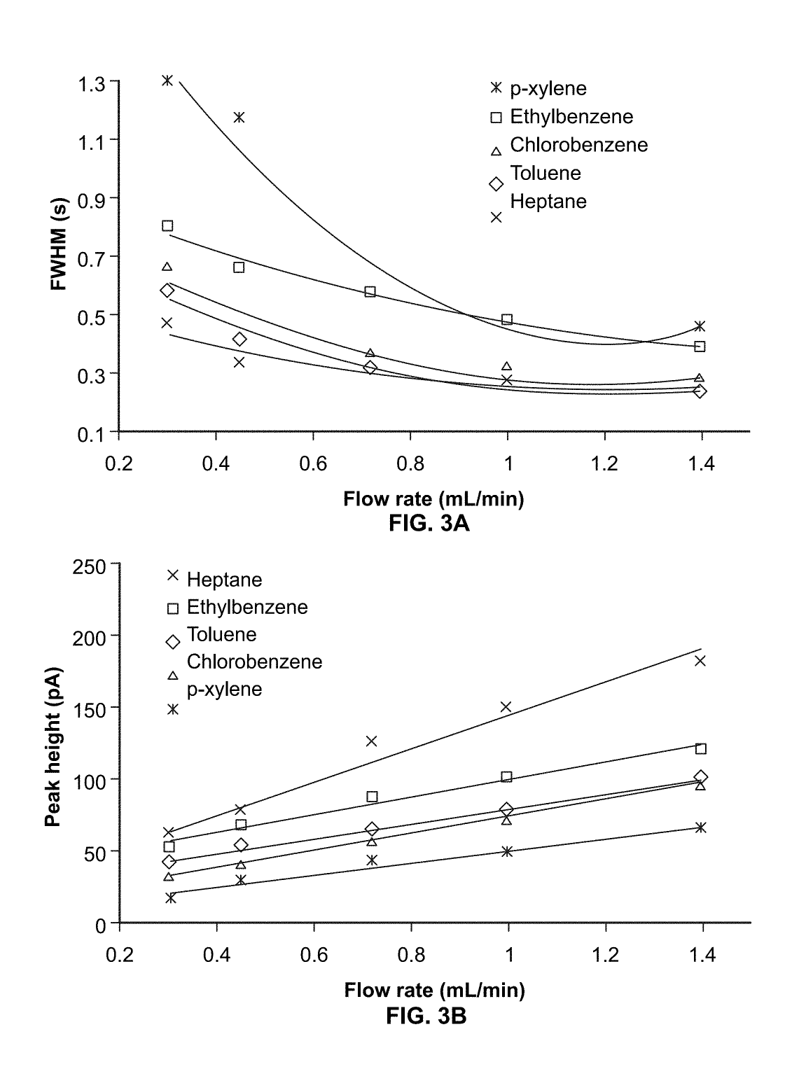

Four test compounds—toluene, tetrachloroethylene, chlorobenzene and ethylbenzene—were used. The different headspace volumes of the test compounds sealed in a vial were sampled using an autosampler (7359A) module to ensure repeatable injections. Assuming ideal gas law behavior, the mass of the compound injected from a saturated vapor above the pure liquid could be calculated from the injection volume and split ratio used for the injection. The injected mass was in the range of 10 pg to 10 ng. The response of the detector was measured in terms of the peak area for each injection. The peak area was selected as an indicator for the quantitative data analysis (instead of peak height) based on our previous results, which indicated that the μDPID is a mass flow rate-sensitive detector (MSD). For any MSD, variations in the flow rate could give rise to changes in the peak height or width; however, negligible changes are observed in the peak area. Therefore, the quantification of a compound in terms of peak area is more accurate. Each data point was repeated three times, and the average peak area was plotted against the injected mass of each test compound (FIG. 4A). Because the injected mass extends over several orders of magnitude, these curves have been plotted on a log-log scale for clarity (FIG. 4B).

These results illustrate that the response of the detector using the T-shape unit 111 remains linear to the injected mass of the test compounds over three orders of magnitude. The R-squared values and their respective slopes obtained by linear regression analysis (forced zero Y-intercept) have been indicated for each curve. Moreover, as evident from FIG. 4B, as the injected mass increased by three orders of magnitude, the sensing signal also increased by 1,000-fold, showing that the linear response of the μDPID spans over three orders of magnitude. The response of μDPID is lower for tetrachloroethylene due to its high ionization potential, which makes it difficult to ionize. The ionization potentials of the remaining VOCs are reasonably close. The ionization potentials for all VOCs used in this report are provided in Table 1.

The sensitivity of the detector is defined as the signal output per unit mass of the compound in the carrier gas. For MSDs, the sensitivity S, is defined as

$$S = \frac{A}{W}$$

where A is the integrated peak area, and W is the mass of the compound. Therefore, the slopes of the curves in FIG. 4A indicate the sensitivity of the μDPID embodiments of the present invention for the particular compounds under investigation. The slopes for tetrachloroethylene, toluene, chlorobenzene and ethylbenzene were 0.036, 0.0488, 0.0841 and 0.2171 (A.s g⁻¹), respectively, showing the higher sensitivity of the μDPID embodiments of the present invention toward ethylbenzene compared to the other test compounds.

The chip-scale GC platform of the present invention was tested following the characterization of the sample injection unit and μDPID. Twelve VOCs—toluene, tetrachloroethylene, chlorobenzene, ethylbenzene, p-xylene, n-nonane, bromobenzene, n-decane, 1,2-dichlorobenzene, n-undecane, 1,2,4-trichlorobenzene and n-dodecane—were selected to evaluate the performance of the embodiment. The following experiments were performed to demonstrate the sampling, separation and detection of compounds with boiling points in the range of 110-216° C. as quickly as possible through the optimization of the flow and temperature programming conditions.

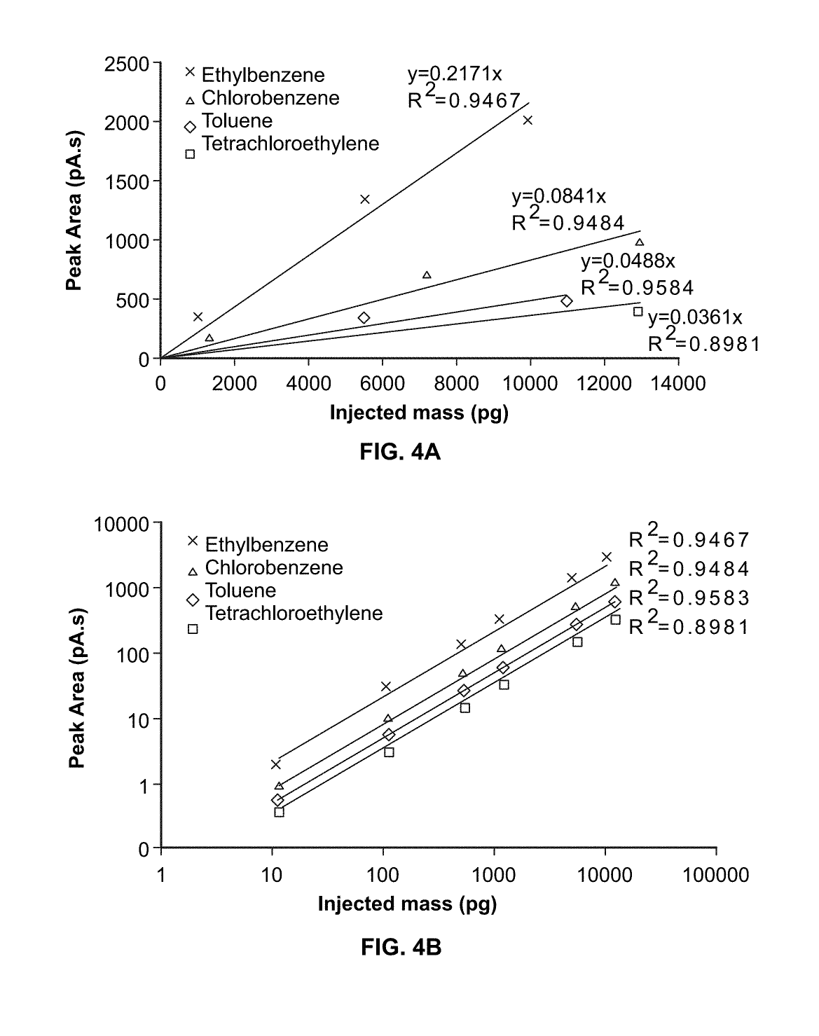

The chip was configured as discussed above with the carrier gas and auxiliary helium supplied by the conventional GC system. The pressures on these supplies were set to 22 and 10 psi, respectively, corresponding to a flow rate of 0.77 mL min⁻¹ at the chip outlet port. The chip temperature was maintained at 40° C. During sampling, the pump was turned on to load the sample into the fluidic connection between the chip and e valve. A sampling time of 3 seconds was considered sufficient for testing the compounds. The chromatogram in FIG. 5 shows the successful identification of nine compounds in 2.5 min, providing good resolution and retention of the compounds. The compounds were eluted in order of decreasing vapor pressure (the pᵥ values are provided in Table 1). The compounds with high vapor pressure tend to remain in the vapor state and thus have more affinity for the mobile phase compared to the stationary phase, which results in their early elution from the μSC. In FIG. 5, n-nonane and bromobenzene were not resolved because their vapor pressures were relatively close. A similar observation was made for n-decane and 1,2-dichlorobenzene. The air peak detected by the μDPID was removed from the chromatogram for clarity. The peak width at the base (w_{b}=4σ) and the retention time (tᵣ) were calculated for every compound from the chromatograms generated by the μDPID. The w_{b} values for p-xylene, C₉/bromobenzene, C₁₀/1,2-dichlorobenzene, all of which have high boiling points, were 7.2, 10 and 27 s, respectively. The resolution (Rₛ) is defined as

$${R}_{s} = \frac{{( {t}_{r} )}_{B} - {( {t}_{r} )}_{A}}{\frac{{( 4 σ )}_{A} + {( 4 σ )}_{B}}{2}} = \frac{2 d}{{( 4 σ )}_{A} + {( 4 σ )}_{B}} \qquad ( 1 )$$

where d is the distance between the peak maxima for the two compounds, A and B. The resolution between p-xylene and C₉/bromobenzene was 2.16, and that between C₉/bromobenzene and C₁₀ was 4.60.

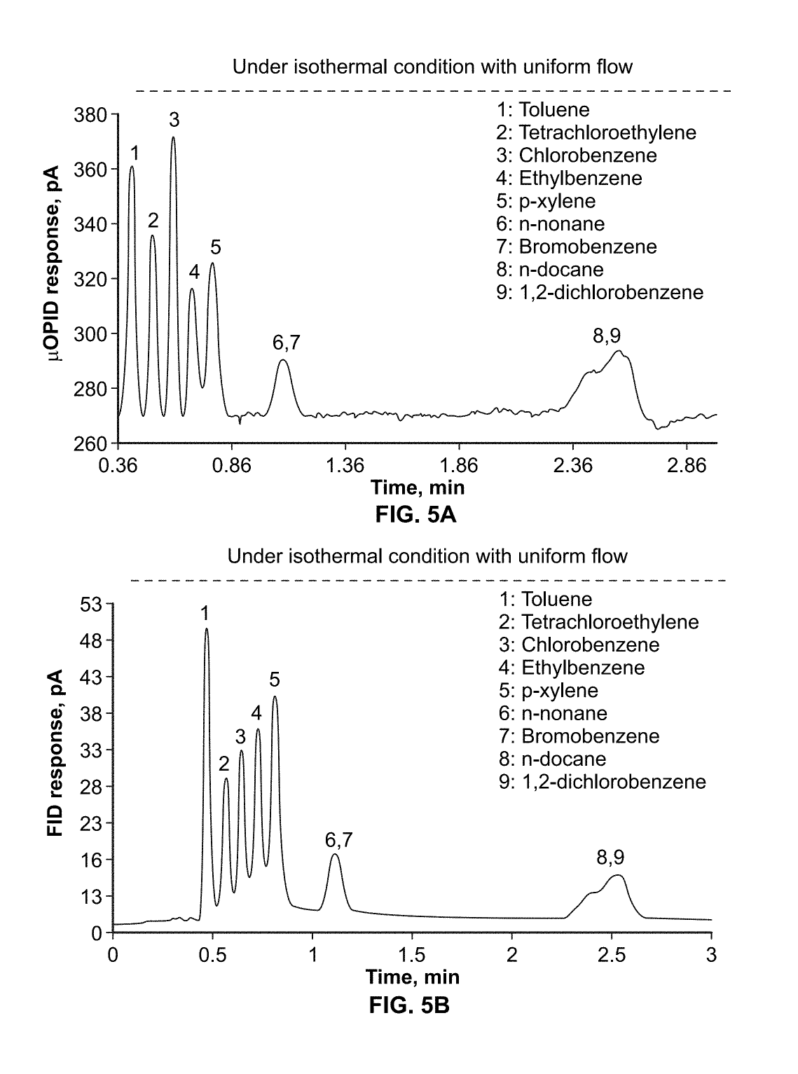

To reduce the analysis time and increase the peak width of the high-boiling-point compounds, a series of experiments was performed under flow programming conditions. One of the best chromatographic results is shown in FIG. 6A. Here, the pressure was initially set to 22 psi (0.77 mL min⁻¹) for 0.7 min and then ramped up to 35 psi (1 mL min⁻¹) at a rate of 35 psi/min. The holdup time was necessary to avoid poor resolution between the first five eluting compounds. In FIG. 6A, the first nine compounds eluted in 1.6 min, which shows a reduction in the analysis time of 36% compared to the previous run. In addition, the C₁₁ peak was observed at 2.8 min. The increased pressure also had a profound impact on the w_{b} value for high-boiling-point compounds, including p-xylene, C₉/bromobenzene and C₁₀/1,2-dichlorobenzene. Reductions in w_{b} of 33%, 40% and 69% were observed for these compounds, respectively. These reductions occur because at increased pressure, less time is available for the longitudinal diffusion of molecules inside the μSC, which results in a narrower peak width. The Rₛ values between p-xylene and C₉/bromobenzene, between C₉/bromobenzene and C₁₀/1,2-dichlorobenzene, and between C₁₀/1,2-dichlorobenzene and C₁₁ were reduced to 2, 4.08, and 8.16, respectively.

Temperature is one of the most important variables in GCs and an effective way of optimizing the analysis time. The superposition of temperature (Tᵢₙᵢₜᵢₐₗ=40° C., ramp=30° C. min⁻¹, T_{final}=65° C.) and flow programming (Pᵢₙᵢₜᵢₐₗ=22 psi, ramp=35 psi min⁻¹, P_{final}=35 psi) has been demonstrated in the chromatogram shown in FIG. 6b. As a result, the analysis was completed in 1.8 min (56% reduction in the analysis time). As expected, further decreases in w_{b} of 41%, 58% and 86% were observed for p-xylene, C₉/bromobenzene and C₁₀/1,2-dichlorobenzene, respectively.

A separate sample containing high-boiling-point compounds, including n-nonane, bromobenzene, n-decane, 1,2-dichlorobenzene, n-undecane, 1,2,4-trichlorobenzene and n-dodecane, was also analyzed. The carrier gas pressure was increased to 35 psi, whereas the auxiliary helium pressure was maintained at 10 psi respective, which corresponds to a flow rate of 0.9 mL min⁻¹ at the chip outlet port. The chip temperature was increased to 70° C. The loading time was increased to 6 because of the low vapor pressure of these compounds. The resulting chromatogram is shown in FIG. 6C. The analysis was completed in 0.8 min, with significantly lower values of w_{b}. w_{b} values of 900 ms, 1.5 seconds, 2.4 and 5.4 seconds were obtained for C₉/bromobenzene, C₁₀/1,2-dichlorobenzene, C₁₁ and 1,2,4-trichlorobenzene/C₁₂, respectively. The data for retention time (tᵣ) and peak width (w_{b}) for these compounds in FIGS. 5A and 6A-C, respectively, have been compiled in Table 2A. The resolutions (Rₛ) for the high-boiling-point compounds are listed in Table 2B.

TABLE 2

| | Isothermal, 40° C. | | Flow programmed run | | Flow & Temp. programmed run | | Isothermal, 70° C. | |
|---|---|---|---|---|---|---|---|---|
| (a) | tᵣ (s) | 4σ (s) | tᵣ (s) | 4σ (s) | tᵣ (s) | 4σ (s) | tᵣ (s) | 4σ (s) |
| Toluene | 24.6 | 4.2 | 24.0 | 6.0 | 24.6 | 4.8 | — | — |
| Tetrachloroethylene | 30.6 | 4.8 | 29.4 | 4.8 | 30 | 4.8 | — | — |
| Chlorobenzene | 36.0 | 4.8 | 34.2 | 4.8 | 34.8 | 4.2 | — | — |
| Ethylbenzene | 40.8 | 5.4 | 40.8 | 4.8 | 39.0 | 4.2 | — | — |
| p-xylene | 46.2 | 7.2 | 44.4 | 4.8 | 43.8 | 4.2 | — | — |
| n-nonane | 64.8 | 10 | 55.2 | 6.0 | 52.8 | 4.2 | 3.60 | 0.9 |
| & | | | | | | | | |
| Bromobenzene | | | | | | | | |
| n-decane | 150 | 27 | 84.6 | 8.4 | 66 | 3.6 | 10.8 | 1.5 |
| & | | | | | | | | |
| 1,2-dichlorobenzene | | | | | | | | |
| n-undecane | — | — | 168 | 12 | 108 | 9.0 | 28.2 | 2.4 |
| 1,2,4-trichlorobenzene | — | — | — | — | — | — | 43.2 | 5.4 |
| & | | | | | | | | |
| n-dodecane | | | | | | | | |

| (b) | $Resolution = \frac{\frac{{( {t}_{r} )}_{B} - {( {t}_{r} )}_{A}}{{( 4 σ )}_{A} + {( 4 σ )}_{B}}}{2}$ | | | |
|---|---|---|---|---|
| Testing conditions | p-xylene-C₉ | Bromobenzene-C₁₀ | 1,2-dichlorobenzene-C₁₁ | C₁₁-1,2,4-trichlorobenzene |
| Isothermal, 40° C. | 2.16 | 4.60 | — | — |
| Flow programmer run | 2.0 | 4.08 | 8.16 | — |
| Flow & Temperature | 2.14 | 3.38 | 6.66 | — |
| programmed run | | | | |
| Isothermal, 70° C. | — | 6.0 | 8.9 | 3.84 |

(a) Summary of the retention time (tᵣ) and peak width at the base (4σ) from the results presented in Figure 5a and Figure 6a-c for μDPID.
(b) Peak resolution (Rₛ) calculated for high boilers including p-xylene, C₉/bromobenzene, C₁₀/1,2-dichlorobenzene, C₁₁ and 1,2,4-trichlorobenzene in Figure 5a and Figure 6a-c. The data presented in Table 2a was used for the calculation of Rₛ.

The chip performance was also evaluated for the analysis of VOCs in aqueous media. Four VOCs—toluene, chlorobenzene, ethylbenzene and p-xylene—were diluted to a concentration of 1 ppm (1 mg L⁻¹) in deionized (DI) water. A small aliquot (500 μL) of the prepared sample was transferred into a 1.8 mL vial. The vial was subsequently sealed to avoid compromising the sample integrity. A sampling time of 6 seconds was considered sufficient for extracting VOCs from the headspace of the sample. The concentration in the headspace was calculated using Henry's Law. The headspace concentrations for toluene, chlorobenzene, ethylbenzene and p-xylene were 270, 152, 323 and 314 ppb, respectively. The representative chromatogram is shown in FIG. 6D, where the separation and detection were completed within 0.6 min. The United States Environmental Protection Agency (EPA) has specified maximum contamination levels (MCLs) for toluene, chlorobenzene, ethylbenzene and p-xylene of 1, 0.1, 0.7 and 10 ppm, respectively.

The embodiments of the present invention are further enhanced by the use of semi-packed columns (SPCs) which provide higher separation efficiencies and sample capacities compared to the open-channel counterparts. The columns of the present invention exhibit the properties of both packed columns—high sample capacity—and open tubular columns—high speed separation, high separation efficiency, and low pressure drop.

In contrast to open channel columns, the SPCs exhibit smaller loss of efficiency with the increase in flow rate, thereby making them suitable for high speed separations. Among a number of different stationary phase materials, one class of compounds that may be used with the embodiments of the present invention in microfluidic columns is ionic liquids (ILs).

ILs constitute a group of organic salts which are liquid below 100° C.; and the ILs that are liquid at room temperature are commonly known as room temperature ionic liquids (RTILs). ILs are polar, chemically inert, nonflammable, thermally stable, easy to synthesize, possess low vapor pressure, and their selectivity can be easily tuned by altering the constituent cation or anion; and hence they have been widely used as stationary phases in conventional gas chromatography. Currently, more than 300 ILs are commercially available and more than a trillion ILs have been estimated. Remarkably, RTILs can separate both polar and non-polar analytes. They have abilities to undergo multiple solvent-solute interactions which include: nonbonding and π-electron interactions, dipole-type interactions, hydrogen bonding (basicity and acidity) interactions, and cohesion and dispersion interactions. ILs show significant hydrogen bond acidity, a feature that is absent in commonly used conventional stationary phases, such as poly(siloxane) and poly(ethylene glycol). Unlike conventional stationary phases which provide limited selectivity variations, ILs offer excellent opportunities for fine-tuning the selectivity of the stationary phase.

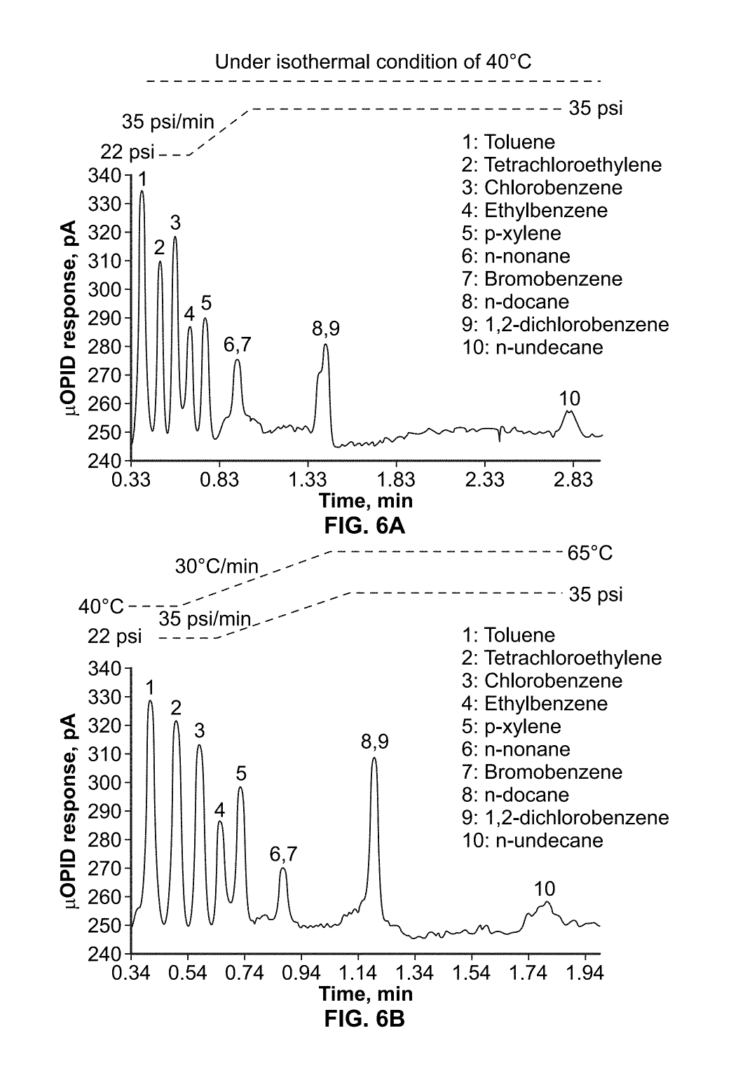

As shown in FIG. 7, in certain embodiments the present invention integrates SPCs with RTILs for high performance separation of complex chemical mixtures. For example, two RTILs, namely, trihexyltetradecylphosphonium bis(trifluoromethylsulfonyl)imide ([P66614][NTf2]) and 1-butylpyridinum bis(trifluoromethylsulfonyl)imide ([BPyr][NTf2]) were used as stationary phases. These RTILs were immobilized inside SPCs using a dynamic coating method. The performance of these columns was evaluated by separating a number of chemical mixtures, including a 15-component mixture of hazardous chemical pollutants, an 8-component mixture of fatty acid methyl esters (FAMEs), and a sample of gasoline. These RTIL-coated columns exhibited sharp and symmetrical peaks, rapid separation times, and high separation efficiency of approximately 2300 plates/m. The selectivity of the two columns were found to be substantially different. Given the fact that the selectivity of RTILs can be easily tuned by altering the constituent ions, the embodiments of the present invention will open up new avenues to develop high-performance micro columns for the separation of a wide range of complex chemical mixtures.

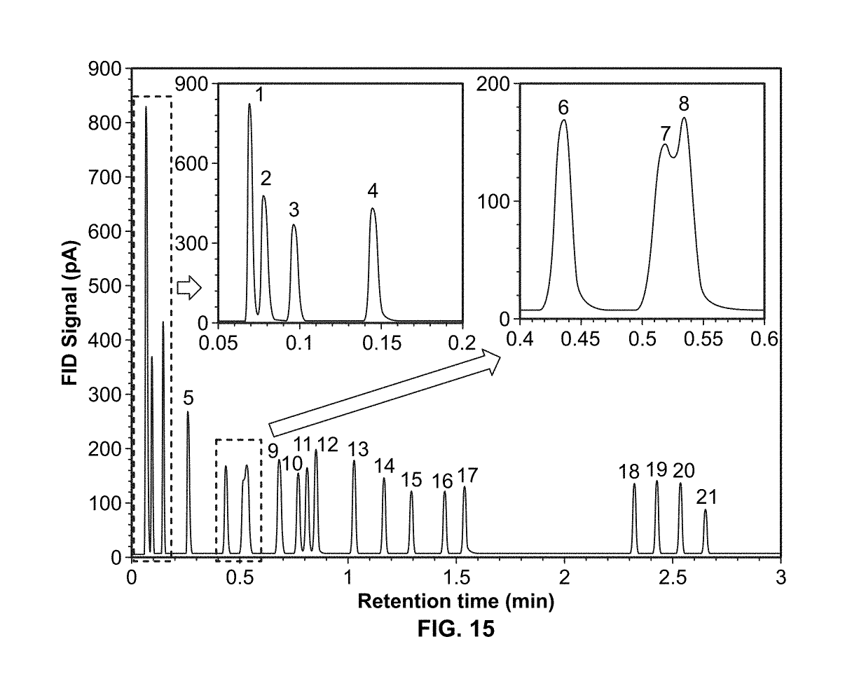

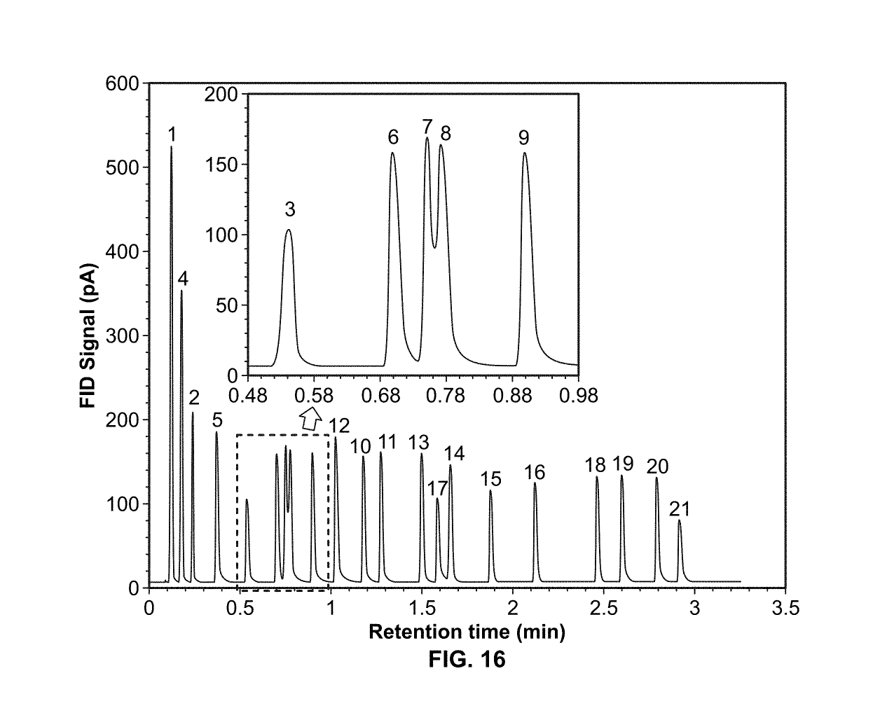

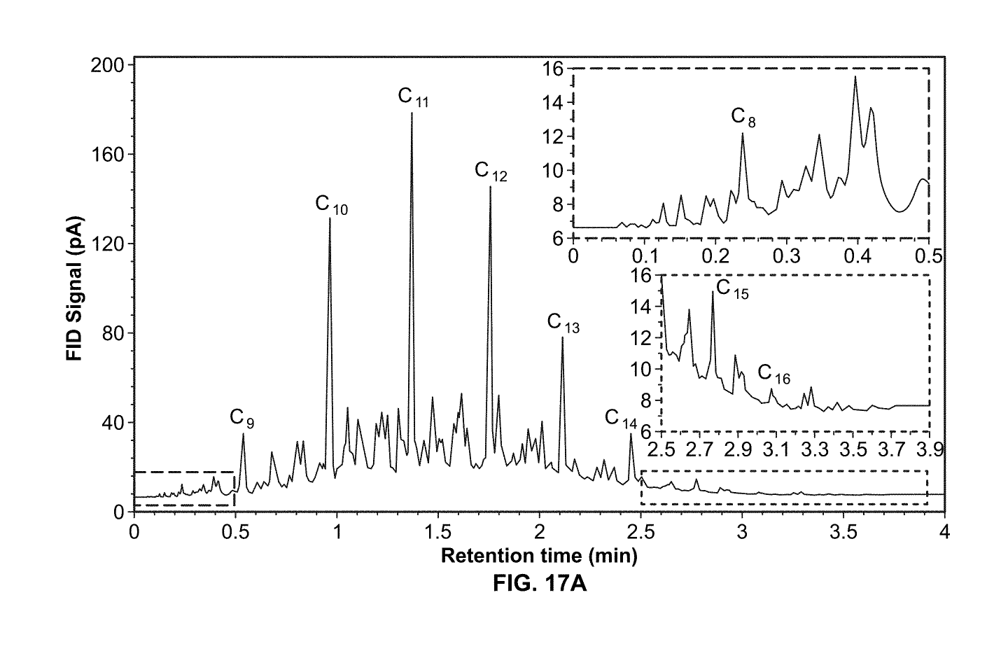

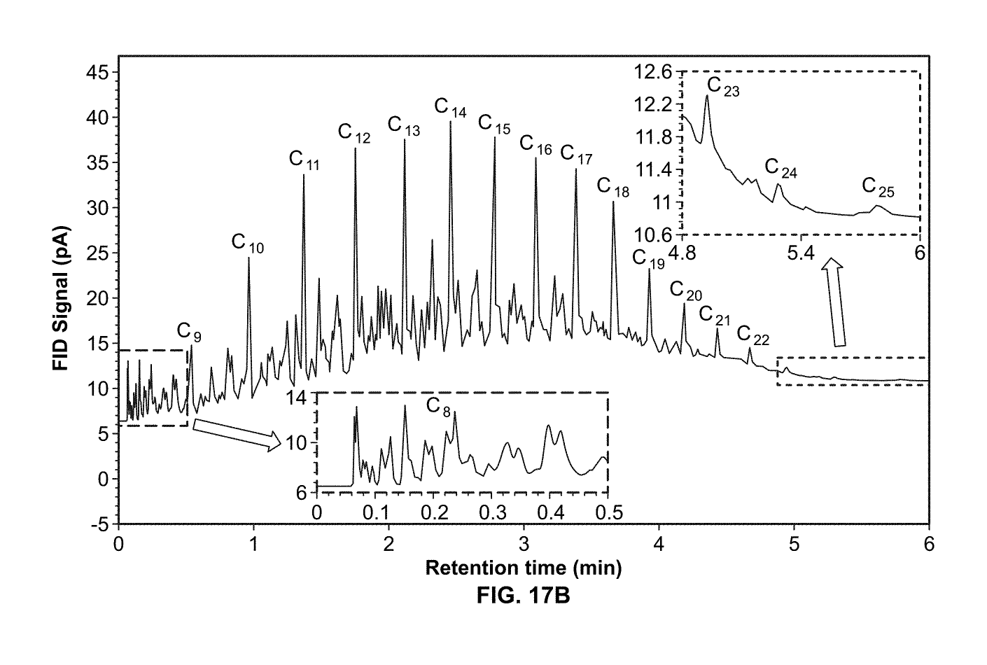

The performance of RTIL-coated SPC can be further enhanced by depositing a thin layer alumina or hafnium oxide or other appropriate materials. The performance increase is shown in FIG. 14. Such high-performance separation columns are useful for the analysis of petrochemicals (FIG. 17A-B).

The RTILs [BPyr][NTf2] and [P66614][NTf2] were obtained from Ionic Liquids Technology, Inc. Silicon wafers were obtained from University Wafers. Borofloat wafers were purchased from Coresix Precision Glass, Inc. Fused silica capillary tubes of 100 μm internal diameter and 200 μm outer diameter were obtained from Polymicro Technologies. A two-part epoxy system was obtained from J-B Weld. Acetone was obtained from Spectrum Chemicals. Benzene, n-hexane, n-heptane, n-octane, n-nonane, benzene, toluene, ethylbenzene, p-xylene, m-xylene, o-xylene, isobutylbenzene, n-butylbenzene, styrene, benzyl chloride, 2-chlorotoluene, 2,5-dichlorotuluene, 1,2-dichlorobenzene, 1,2,4-trichlorobenzene, naphthalene, 2-nitrotoluene, 3-nitrotoluene, 4-nitrotoluene, and a standard mixture of C7-C30 saturated alkanes (in hexane) were obtained from Sigma Aldrich. A mixture containing 8 fatty acid methyl esters (FAME #20 mix) was obtained from Restek Corporation. Gasoline (octane rating of 87), diesel, and kerosene were obtained from local stores. Air and ultrapure helium were purchased from Airgas, Inc. Methane was obtained from Air Liquide, Inc. Ultrapure hydrogen for flame ionization detector (FID) was produced by using Parker Domnick Hunter hydrogen generator All of these chemicals were used as received without further purification.

The separation columns were produced employing microelectromechanical system (MEMS) processes including photolithography, etching, and silicon-glass anodic bonding. The fabricated columns were 1-meter long, 240 μm deep and 190 μm wide with circular pillars of 20 μm diameter and 40 μm pillar spacing.

A silicon wafer was cleaned using standard RCA cleaning, and then it was primed with hexamethyldisilazane (HMDS) which acts as an adhesion promotor for a photoresist. This is followed by the deposition of 8 μm thick AZ9260 photoresist by spin coating at 2000 rpm for 1 minute. The photoresist-coated wafer was then soft-baked at 110° C. for 1 minute. The pattern from a chrome mask was transferred to the soft-baked wafer by using ultra violet light source and a mask aligner. The wafer was then hard-baked at 110° C. for 3 minutes. Following this, the wafer was anisotropically etched using Alcatel deep reactive ion etcher (DRIE) via a standard Bosch process with SF₆ as etching and C₄F₈ passivation reactants. The photoresist was removed by treating the wafer with acetone and subsequently with piranha solution. A 10-nm layer of aluminum oxide was deposited at 300° C. via atomic layer deposition using trimethylaluminum and water as precursors. Similarly, hafnium oxide was deposited using tetrakis(dimethylamino)hafnium and water as precursors. The etched silicon wafer was anodically bonded with a 700 μm thick Borofloat wafer (Coresix Precision Glass) at 1250 V and 400° C. for 45 minutes, and finally the wafer was diced into individual devices.

The outlet and inlet of the column were then connected to fused silica capillary tubing (internal diameter: 100 μm and outer diameter: 200 μm) using J-B Weld twin tube epoxy in order to connect the micro column to GC injection port and detector. The total length of the two capillary tubes was 27 to 30 cm.

A freshly prepared solution of an RTIL in acetone at a concentration of 4 mg/mL to 16 mg/mL (for dynamic) and 2 mg/mL (for static) was used for deposition of RTILs into the channels of the SPCs. Both static and dynamic coating methods were used. Static coating did not produce high yields for SPCs since air bubbles were formed during the coating procedure preventing the deposition of the RTILs in some of these columns. Therefore, the columns coated with the dynamic technique for our chromatographic evaluation of RTIL-functionalized SPCs. The columns coated with 8 mg/mL of RTIL solution showed optimal performance and these were evaluated in more detail.

The separations were performed using an Agilent 7890A GC system equipped with an automatic sampler (7693A) and two FIDs. Helium was used as a carrier gas. Before installation, the columns were flushed with nitrogen for 30 minutes. Following the installation, each column was conditioned from 30 to 200° C. at a ramp rate of 2° C./min followed by holding at 200° C. for 15 minutes, while the inlet pressure was held at 10 psi during the column conditioning. The inlet temperature was kept at 280° C. and the detector temperatures was kept at 300° C. during the measurements.

[P66614][NTf2] and [BPyr][NTf2] were selected as the model RTILs since they are expected to show altered selectivity due to the presence of distinctly different cations. Among these two RTILs, [P66614][NTf2] has been previously used as a GC stationary phase and it has been shown to be stable up to 380° C. RTIL [BPyr][NTf2], however, has not been used as a stationary phase in GCs.

A thin film of [BPyr][NTf2] was coated inside a fused silica capillary tubing. Then the coated capillary was heated in the GC oven. The temperature was ramped from 30 to 320° C. at a rate of 10° C./min. FID signal during this time did not show any significant rise in its baseline indicating that the RTIL is stable at least up to 320° C., which is sufficient for the separation of a wide range of analytes.

The coated SPCs were imaged using an optical microscope. FIGS. 7A-7C show the optical images of a portion of the uncoated and coated columns. The dynamic coated columns show some isolated microdroplets of varying sizes, indicating that the RTIL deposits were not continuous.

The separation efficiency of each column was evaluated by determining the height-equivalent-to-a-theoretical plate (HETP) or plate numbers (N) as a function of the average carrier gas linear velocity. The retention time of methane was taken as the hold-up time. HETP or N were determined at 100° C. isothermal conditions using naphthalene as a probe. The following equations were used for calculations.

$$\begin{matrix}\overline{u} = \frac{L}{{t}_{M}} & ( 1 ) \\ k = \frac{{t}_{R} - {t}_{M}}{{t}_{M}} & ( 2 ) \\ N = 5.545 {( \frac{{t}_{R}}{{w}_{h}} )}^{2} & ( 3 ) \\ H = \frac{L}{N} & ( 4 )\end{matrix}$$

where, ū is average linear velocity, L is the length of a column, t_{M} is the retention time of methane, t_{R} is the retention time of the compound of interest, N is the number of theoretical plates (or plate numbers), wₕ is the peak width at half height of the compound of interest, and H is HETP.

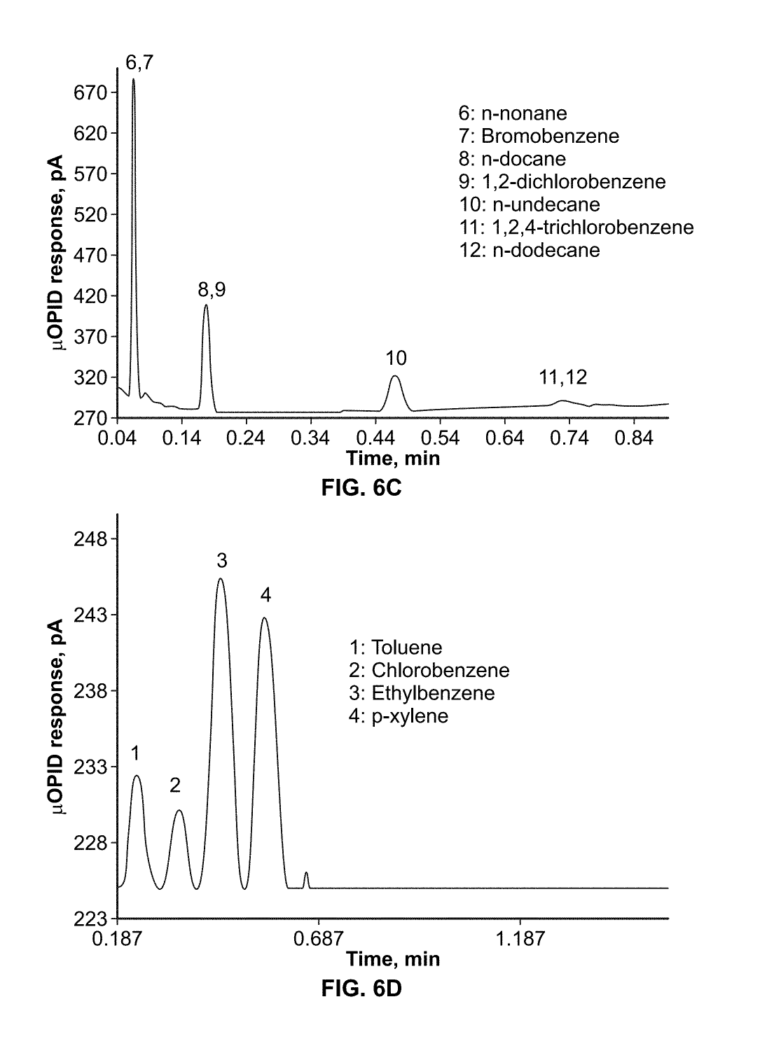

FIG. 8 shows the Golay plots (H vs ū) for the columns coated with the two RTILs. The minimum plate height for the [P66614][NTf2]-coated column was found to be 0.047 cm (maximum number of theoretical plates of 2128 plates per meter) at a flow rate of 24 cm/sec (k for naphthalene=14.5). Similarly, the minimum plate height for the [BPyr][NTf2]-coated column was found to be 0.044 cm (maximum number of theoretical plates of 2273 plates per meter) at a flow rate of 23 cm/s (k for naphthalene=8.5). As evident from the Golay plots, the loss of efficiency was not very substantial as the flow rate increases.

FIG. 14 shows that the number of plates were greatly enhanced by coating the columns with alumina or hafnium oxide via atomic layer deposition.

The separation performance of the columns was characterized by separating a number of different mixtures. The first test mixture was a 15-component mixture comprising hydrocarbons, aromatic halides, and nitroaromatic compounds. These compounds include heptane, benzene, toluene, ethylbenzene, p-xylene, m-xylene, o-xylene, styrene, benzyl chloride, 1,2-dichlorobenzene, 1,2,4-trichlorobenzene, naphthalene, 2-nitrotoluene, 3-nitrotoluene, and 4-nitrotoluene. The boiling points of these compounds range from 80.1 to 238° C. These toxic chemicals are widely distributed in environmental and occupational settings, and there has been substantial scientific interest in monitoring these chemicals.

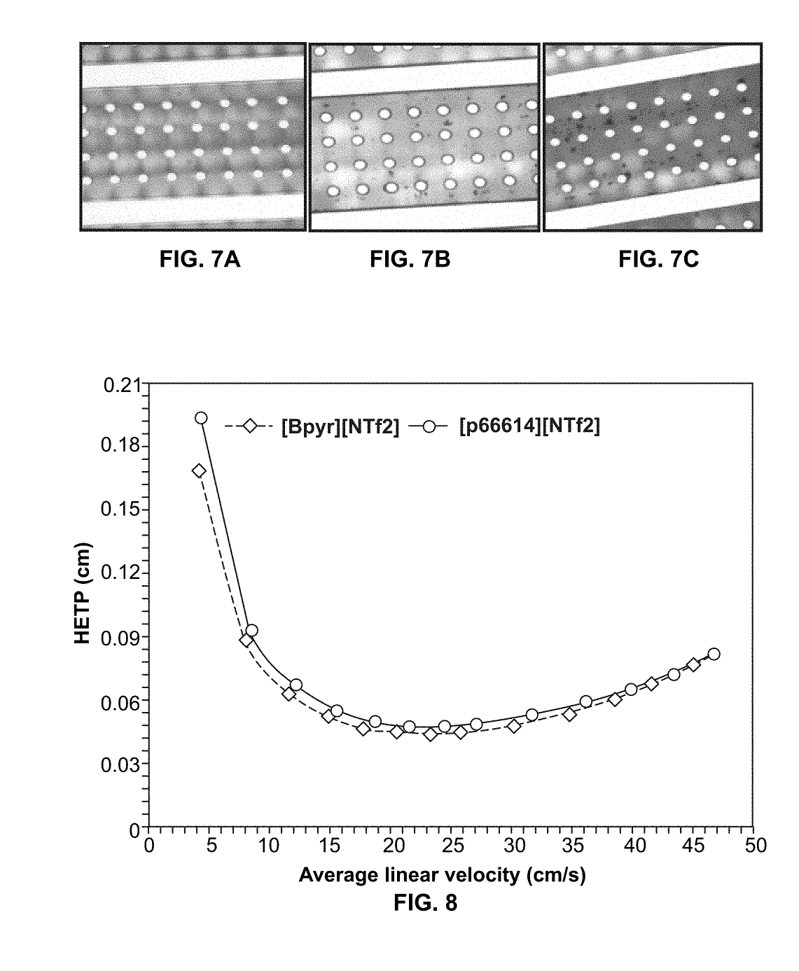

FIGS. 9A-9B show chromatograms for the separation of this mixture. These chromatograms were obtained under temperature and pressure programmed conditions. The number of theoretical plates calculated for naphthalene under these conditions was 32,000 (for FIG. 9A) and 27,000 (for FIG. 9B) plates per meter. It is evident from these chromatograms that these compounds are well-resolved (except p- and m-xylenes), the peaks are sharp and symmetrical, and the separation is very rapid. Notably, the change in cation produced a considerable effect on separation selectivity as evident by the substantial changes in the relative retention. A change in elution order of some compounds is observed. In order to check the reproducibility, we coated two different columns with two different solutions of [BPyr][NTf2], the difference in retention times and number of theoretical plates for this set of analytes was less than 10% (data not shown).

Another group of analytes was a standard mixture containing 8 fatty acid methyl esters (FAMEs) obtained from Restek Corporation. Analysis of FAMEs is very important for food and biodiesel characterization. The different FAMEs present in our test mixture were methyl caprylate (C8:00), methyl caprate (C10:00), methyl laurate (C12:00), methyl myristate (C14:00), methyl palmitate (C16:00), methyl stearate (C18:00), methyl oleate (C18:01), and methyl linoleate (C18:02). The mixture was dissolved in hexane (50 mg of total FAMEs was dissolved in 1 mL hexane).

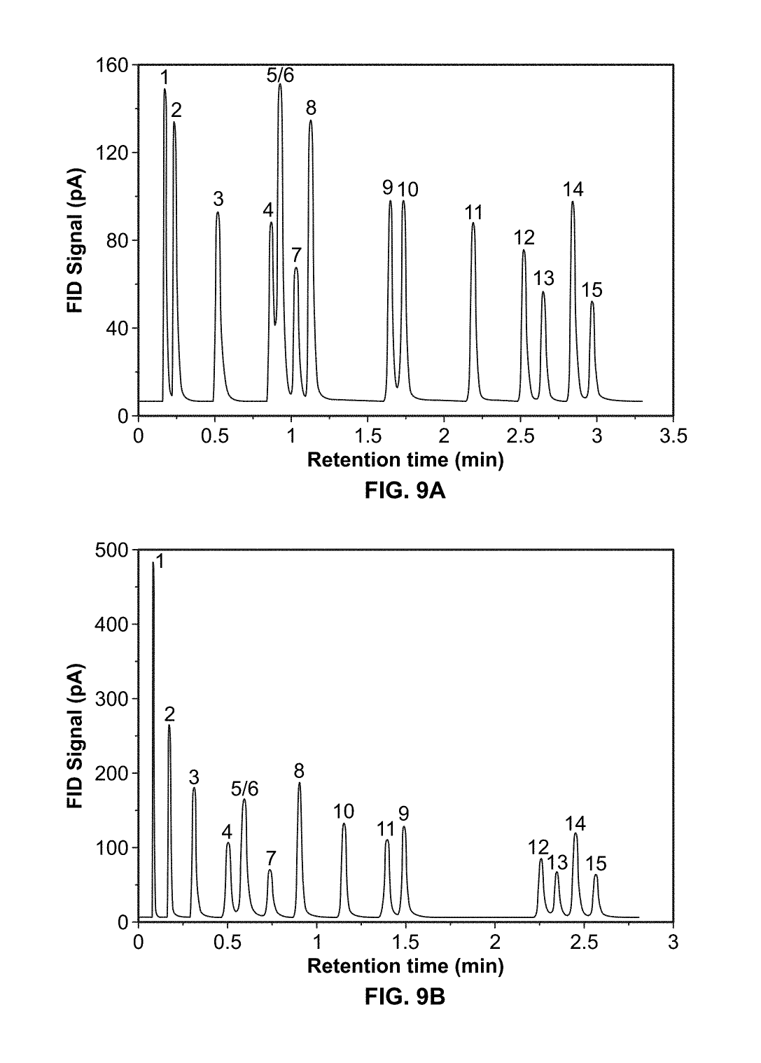

FIG. 10A shows that [P66614][NTf2]-coated column could not separate C18:00, C18:01, and C18:02, while other FAMEs were baseline separated. Interestingly, as shown in FIG. 10B, [BPyr][NTf2]-coated column was able to baseline separate all these 8 compounds in less than 4 minutes.

The third mixture was a sample of gasoline. Automotive gasoline is a complex mixture of mostly low-boiling hydrocarbons, but it also contains hazardous chemicals such as BTEX (benzene, toluene, ethylbenzene, and xylenes) and naphthalene. The separation and determination of BTEX, naphthalene, and other hazardous chemical entities in gasoline and gasoline-contaminated environmental samples is crucial for efficient health risk assessment and management of occupational and environmental exposure to these chemicals.

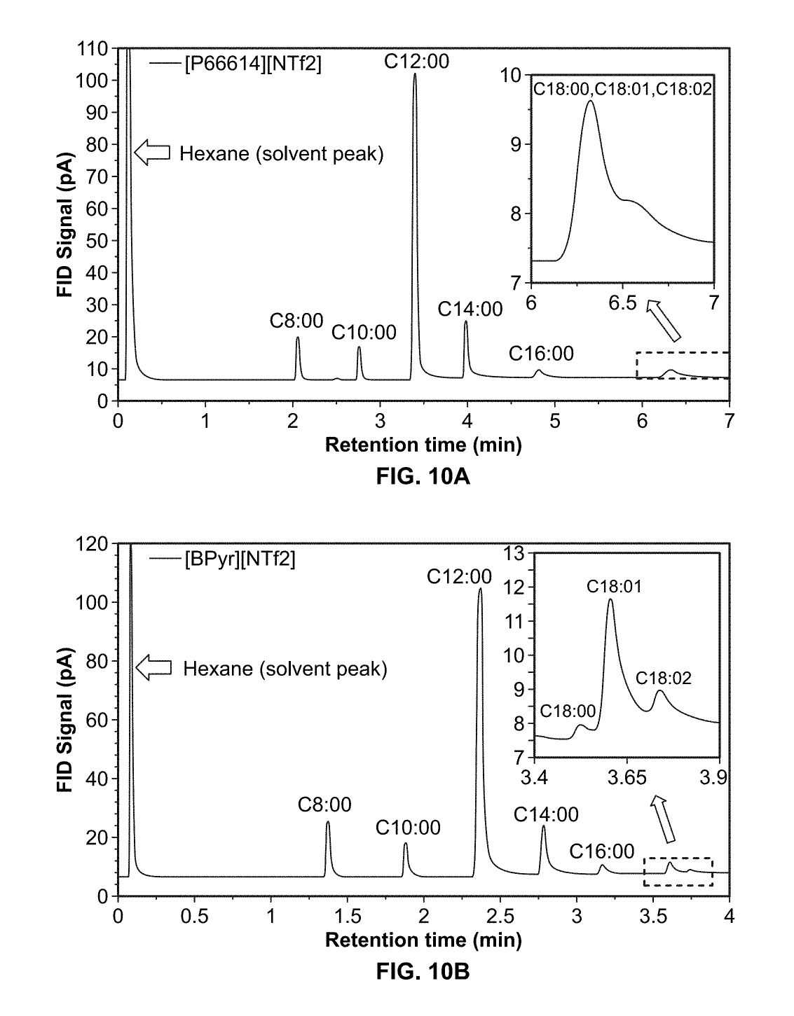

FIG. 11 shows the chromatogram for the separation of neat gasoline sample using [BPyr][NTf2]-coated column. It shows that the major fraction is low-boiling hydrocarbons which elute first. In addition, there are a number of well separated peaks.

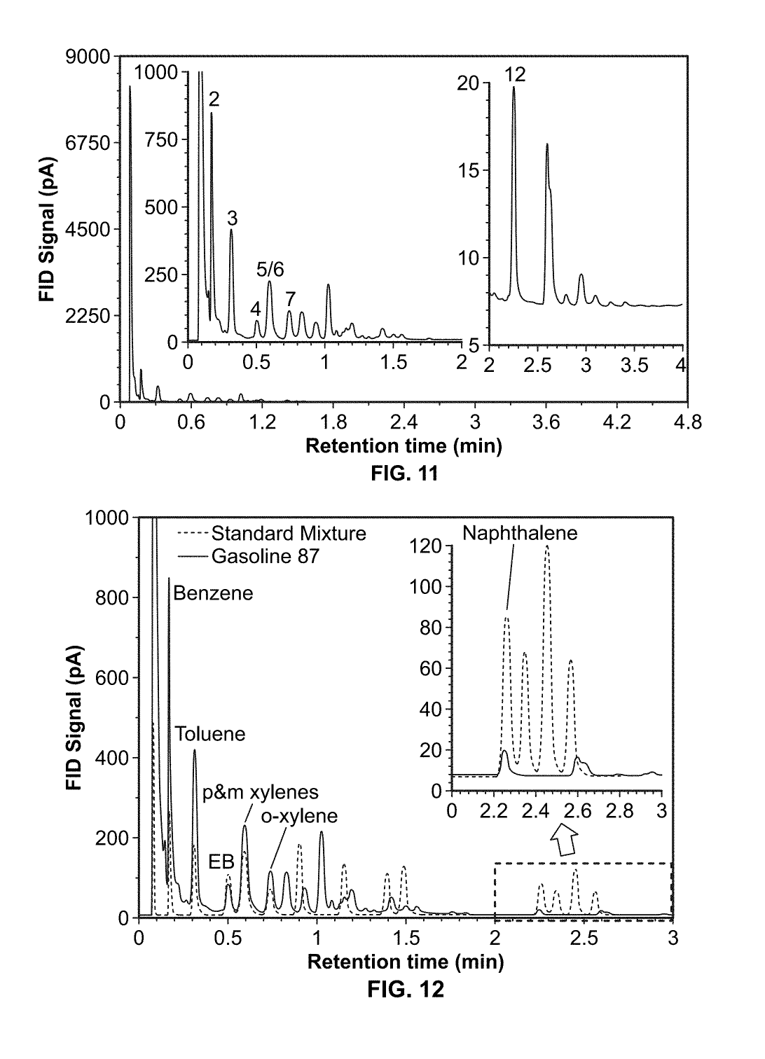

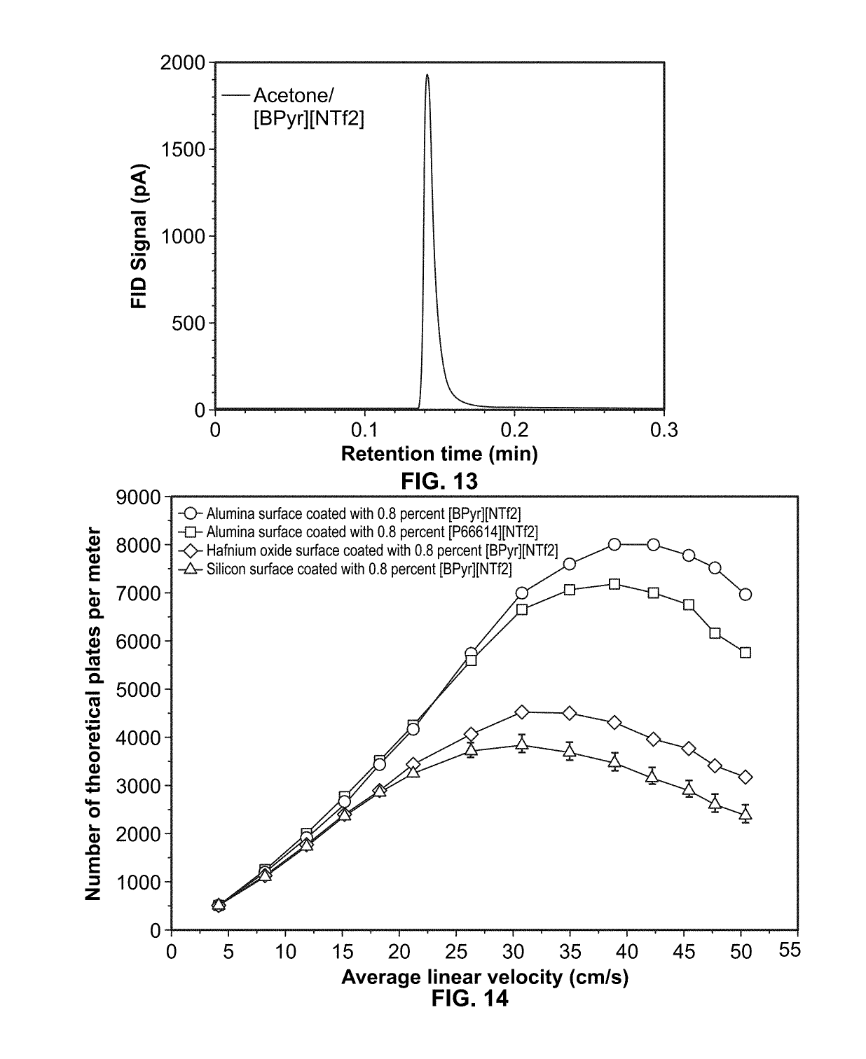

FIG. 12 shows an overlay of chromatograms for gasoline and 15-component standard mixture obtained by using [BPyr][NTf2]-coated column. By matching the retention times, we can clearly see well resolved peaks of BTEX and naphthalene. The gasoline was also separated by using [P66614][NTf2]-coated columns although some of the peaks of BTEX were not well resolved using this stationary phase.

Overall, these improved columns provide a series of advantages over the currently available micro columns. The first advantage is that these columns provide very sharp and symmetrical peaks. A careful examination of chromatograms of the earlier works or the commercially available micro columns shows that there is a significant peak broadening, fronting, or tailing. These effects arise due to either pooling of stationary phase at the corners of the rectangular columns or limited sample capacity of the columns. Given the fact that the present invention achieved symmetrical peaks for a number of polar and non-polar compounds, it is presumed that there are less pooling effects in the case of RTILs.

In addition, the embodiments of the present invention were able to immobilize the RTILs without having to pretreat the columns with sodium chloride although this pretreatment may enhance the separation performance. It is presumed that the presence of pillars may partially prevent the pooling of the RTILs inside the column. A highly polar compound, acetone, was passed through a column coated with [BPyr][NTf2], and as evident from FIG. 12, the peak is sharp (N=2121 per meter) and symmetrical, although a slight tailing was observed. Note that approximately 200 ng of acetone was injected to obtain the chromatogram shown in FIG. 12, and no column overloading was noticed.

The second advantage of this research is that it provides a route to create micro columns having different selectivity for separation of a wide range of chemical mixtures. Changing or modifying the constituent ions of an IL will modify the solvation properties of an IL, thereby altering the relative retention times. The separation performance of these columns can also be enhanced by modifying the surface with metal oxides before coating with an RTIL.

Although researchers are successful in the development of micro columns for high speed and highly efficient separation by using stationary phases, such as sputtered silica or graphite and atomic layer deposited alumina, these stationary columns do not offer tunable selectivity. The third advantage offered by the embodiments of the present invention is the speed of separation. For example, some embodiments were able to baseline separate BTEX in less than 50 seconds and baseline separate naphthalene from gasoline in less than two and a half minutes. This is a substantial improvement in speed as compared to the current state-of-the-art micro GC technology. As discussed above, SPCs provide high efficiency and flatter Golay plots. It is therefore possible to work at higher flow rates to increase the separation speed without a significant loss in separation efficiency.

In yet other embodiments, surface modification of the channels of SPCs prior to coating with RTILs may be performed. The surface of the silicon channels, including the pillars, may be modified by depositing a thin film of hafnium oxide or aluminum oxide via atomic layer deposition (ALD). A thin film of an RTIL was subsequently deposited on the surface of the oxide layer, and the performance of these columns was evaluated by separating a number of complex chemical mixtures, including a 21-component mixture of hazardous chemical pollutants, a sample of kerosene, and a sample of diesel. A vastly improved separation performance, including an enhancement in separation efficiency was observed due to the presence of an oxide film underneath the RTIL layer. The number of theoretical plates, as measured by using naphthalene as a probe at 100° C., for the column with an RTIL immobilized on aluminum oxide was found to be as high as 8,000 plates/m, which is more than 2 times the number of theoretical plates obtained by depositing the same RTIL on silicon surface. This shows that by using RTILs in SPCs to create chip-based separation columns, devices can be created that rival the commercial capillary columns.

In yet other embodiments, other surface coatings that may be applied as an intermediate layer between the silicon surface and the one or more room temperature ionic liquid films include oxides and other materials, such as metal, metal carbides, metal nitrides, known to those of skill in the art that will increase the uniformity of the one or more room temperature ionic liquid films.

The RTILs may be deposited inside the channels of the separation columns using a dynamic coating procedure at room temperature by employing a freshly prepared solution of an RTIL in acetone. The concentration of RTIL in the solution was varied from 0.4 to 1.6% (w/v). The entire column was first filled with a solution of RTIL, and the solution was removed by using nitrogen gas at a pressure of 10 psi. After removing the bulk of the solution, the column was placed under vacuum to evaporate the residual solvent in quiescent conditions.

The maximum plate numbers (Nₘₐₓ) for silicon surface coated with [BPyr][NTf₂] was found to be 3822±195 per meter at an optimum average flow velocity of 31 cm·s⁻¹. By coating [BPyr][NTf₂] on hafnium oxide surface, the Nₘₐₓ was found to increase by 18%. Interestingly, a column prepared by coating [BPyr][NTf₂] on alumina surface produced Nₘₐₓ of 8,000 plates m⁻¹, which is more than double the maximum plates numbers obtained by immobilizing the same RTIL on silicon surface. Another RTIL, [P₆₆₆₁₄][NTf₂], immobilized on alumina surface produced Nₘₐₓ of 7,158 plates m⁻¹. This indicates that highly efficient separation columns can be designed by suitably modifying the silicon surface prior to RTIL deposition.

In other embodiments, the present invention provides another way to preconcentrate the sample. Instead of using the T-shape unit, this embodiment uses micropillars coated with adsorbents to trap analytes of interest and release them on demand through thermal desorption process. This arrangement may be integrated with the T-shaped sample injection unit.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiments, methods, and examples, but by all embodiments and methods within the scope and spirit of the disclosure.

What is claimed is:

1. A miniaturized gas chromatography system integrated on single chip comprising:
a sample injection unit;
a separation column having an inlet, an exit and an interior surface;
at least one detector located at the separation column exit; and
said sample injection unit having a T-shaped configuration.

2. The miniaturized gas chromatography system of claim 1 wherein the system reduces the need for heated interconnect lines between individual components by reducing the footprint, cost and power budget for the operation of the system.

3. The miniaturized gas chromatography system of claim 1 wherein the system reduces band-broadening of compounds having high molecular weight thus improving the performance of the system.

4. The miniaturized gas chromatography system of claim 1 wherein said interior surface of said separation column is coated with a room temperature ionic liquid film.

5. The miniaturized gas chromatography system of claim 1 further including a plurality of separation columns each having an interior surface, said interior surfaces coated with one or more room temperature ionic liquid films.

6. The miniaturized gas chromatography system of claim 1 wherein said interior surface of said separation column has a silicon surface, said silicon surface coated with an alumina surface, said alumina surface coated with a one or more room temperature ionic liquid films.

7. The miniaturized gas chromatography system of claim 1 wherein said interior surface of said separation column has a silicon surface, said silicon surface coated with a hafnium oxide surface, said hafnium oxide surface coated with a one or more room temperature ionic liquid films.

8. The miniaturized gas chromatography system of claim 4 wherein said at least one detector has a response that remains linear to an injected mass of a test compound.

9. The miniaturized gas chromatography system of claim 4 wherein said at least one detector has a response that remains linear to an injected mass of a test compound over three orders of magnitude.

10. The miniaturized gas chromatography system of claim 4 wherein said at least one has a minimum detection limit of 10 pg.

11. The miniaturized gas chromatography system of claim 10 wherein the detection limit of 10 pg is improved by optimizing the gap between the excitation electrodes, the collector volume, packaging of the detector and density of micro-plasma.

12. The miniaturized gas chromatography system of claim 1 wherein said system has the ability to operate under temperature programming conditions to reduce analysis time.

13. The miniaturized gas chromatography system of claim 1 wherein said system can be integrated with other types of detectors such as micro thermal conductivity detector (μTCD).

14. The miniaturized gas chromatography system of claim 1 wherein said system has a separation efficiency of approximately 2300 plates/m.

15. The miniaturized gas chromatography system of claim 1 wherein separation of 15 compounds is achieved in approximately 3 minutes with a separation efficiency of approximately 2300 plates/m.

16. The miniaturized gas chromatography system of claim 4 having a separation efficiency of approximately 8000 plates/m.

17. The miniaturized gas chromatography system of claim 5 having a separation efficiency of approximately 8000 plates/m.

18. The miniaturized gas chromatography system of claim 1 wherein said interior surface of said separation column has a silicon surface, said silicon surface coated with a gold surface, said gold surface coated with a one or more room temperature ionic liquid films.

19. The miniaturized gas chromatography system of claim 1 wherein said interior surface of said separation column has a silicon surface, said silicon surface coated with a platinum surface, said platinum surface coated with a one or more room temperature ionic liquid films.

20. The miniaturized gas chromatography system of claim 1 wherein said interior surface of said separation column has a silicon surface, said silicon surface coated with an inert metal surface, said inert metal surface coated with a one or more room temperature ionic liquid films.

21. The miniaturized gas chromatography system of claim 1 further including a pump, said pump in communication with a branch of said T-shaped sample injection unit, said pump creates a negative pressure to load a gaseous sample present above the headspace of a liquid into a fluidic channel formed by two branches of said T-shaped sample injection unit and away from said separation column.

22. The miniaturized gas chromatography system of claim 1 wherein the system is configured to introduce samples at full width, at half maximum of approximately 200 ms at room temperature.

23. The miniaturized gas chromatography system of claim 1 including a heater, said heater adapted to heat the T-shaped injector.

24. The miniaturized gas chromatography system of claim 1 wherein said T-shaped sample injection unit is configured to inject liquid samples.

25. The miniaturized gas chromatography system of claim 1 further including a plurality micropillars coated with adsorbent to trap analytes of interest and release them on demand through thermal desorption process.

26. The miniaturized gas chromatography system of claim 21 wherein said pump after creating said negative pressure creates a positive pressure which injects a sample into said separation column.

27. The miniaturized gas chromatography system of claim 26 further including a valve which cooperates with said pump to create said negative pressure and said positive pressure.

28. The miniaturized gas chromatography system of claim 5 wherein said interior surface of said separation column has a silicon surface, said silicon surface coated with a material that increases the uniformity of said one or more room temperature ionic liquid films.

29. The miniaturized gas chromatography system of claim 5 wherein said interior surface of said separation column has a silicon surface, said silicon surface coated with an oxide that increases the uniformity of said one or more room temperature ionic liquid films.

30. The miniaturized gas chromatography system of claim 5 wherein said RTILs have different constituent ions.

31. The miniaturized gas chromatography system of claim 5 having a separation efficiency of approximately 8000 plates/m and where the separation of 21 compounds is achieved in approximately 3 minutes.

32. The miniaturized gas chromatography system of claim 1 wherein said interior surface of said separation column has a silicon surface, said silicon surface coated with a metal carbide surface, said metal carbide surface coated with a one or more room temperature ionic liquid films.

33. The miniaturized gas chromatography system of claim 1 wherein said interior surface of said separation column has a silicon surface, said silicon surface coated with a metal nitride, said metal nitride surface coated with a one or more room temperature ionic liquid films.

34. A miniaturized gas chromatography system integrated on single chip comprising:
a sample injection unit;
a separation column having an inlet, an exit and an interior surface;
at least one detector located at the separation column exit; and
said sample injection unit including micropillars coated with adsorbent to trap analytes of interest and release them on demand through a thermal desorption process.
